(19) United States
(12) Patent Application Publication
(10) Pub. No.: US 2024/0403369 A1
(43) Pub. Date: Dec. 5, 2024

(54) METHODS AND SYSTEMS FOR TRAINING ARTIFICIAL INTELLIGENCE-BASED MODELS USING LIMITED LABELED DATA

(71) Applicant: MASTERCARD INTERNATIONAL INCORPORATED, Purchase, NY (US)

(72) Inventors: Akshay Sethi, New Delhi (IN); Ayush Agarwal, Roorkee (IN); Nancy Agrawal, Gurgaon (IN); Siddhartha Asthana, New Delhi (IN); Sonia Gupta, Gurgaon (IN)

(73) Assignee: MASTERCARD INTERNATIONAL INCORPORATED, Purchase, NY (US)

(21) Appl. No.: 18/733,518

(22) Filed: Jun. 4, 2024

(30) Foreign Application Priority Data
Jun. 5, 2023 (IN) 202341038556

(51) Int. Cl. G06F 16/906; G06F 16/901

(52) U.S. Cl. CPC G06F 16/906; G06F 16/901

(57) ABSTRACT

Methods and systems for training artificial intelligence (AI)-based models using limited labeled data are disclosed. The method performed by a server system includes accessing a tabular dataset including tabular data that further labeled data and unlabeled data. Method includes generating labeled features including labeled numerical features and labeled categorical features based on the labeled data and generating unlabeled features including unlabeled numerical features and unlabeled categorical features based on the unlabeled data. Method includes determining, via a first transformer model, a contextual numerical embeddings based on the labeled numerical features and the unlabeled numerical features. Method includes determining, via a second transformer model, a contextual categorical embeddings based on the labeled categorical features and the unlabeled categorical features. Method includes generating a concatenated embeddings based on concatenating the contextual numerical embeddings and the contextual categorical embeddings. Method includes generating a third transformer model based on the concatenated embeddings.

### TECHNICAL FIELD

The present disclosure relates to artificial intelligence-based processing systems and, more particularly, to electronic methods and complex processing systems for methods and systems for training artificial intelligence (AI)-based models using limited labeled data.

### BACKGROUND

With the advent of technology, the concept of deep learning is used in domains where huge, annotated datasets (labeled datasets) are readily available, and such domains correspond to vision processing and text processing. However, in domains such as healthcare, finance, recommender systems, internet advertising, portfolio optimization, and the like, such annotated datasets are not easily available, instead huge unlabeled data is available and the data is majorly in tabular form. Therefore, multiple approaches are proposed for deep learning using unsupervised (self-supervised) and semi-supervised deep learning models. Self-supervised learning refers to a type of machine learning (ML) technique in which the machine uses unlabeled data and learns on itself without any supervision. Semi-supervised learning refers to a type of ML technique that uses a combination of a small amount of labeled data and a large amount of unlabeled data to train models.

With further advancement in technology, Tree-based ensemble approaches including gradient-boosted decision trees, are developed and used as the state of the art for various tasks such as prediction based on the tabular data. However, decision tree-based approaches have a number of drawbacks such as a lack of reliable probabilistic estimates, pretraining methods are not utilized, continual learning of streaming data being unavailable, and heavy feature engineering is required.

Further, the introduction of deep neural networks overcomes such drawbacks, as they allow for various pre-training strategies, are effective at continual learning, and can produce calibrated probability estimates and automated features. Approaches utilizing deep neural networks may include approaches related to fully supervised learning, self-supervised learning, or semi-supervised learning.

In the case of using fully supervised learning on tabular data, due to the success of attention-based architectures in several domains, multiple approaches are proposed to use attention-based architectures for tabular Deep Learning. Examples of such approaches include an Attentive Interpretable Tabular Learning method (Tabnet®), Tabular Data Modeling Using the Contextual Embeddings method (TabTransformer®), and a Non-Parametric Transformer method.

Further, the most recent approaches in the case of self-supervised tabular learning that focus on pre-text tasks include the Value Imputation and Mask Estimation (VIME) framework, Improved Neural Networks for Tabular Data via Row Attention and Contrastive Pre-Training uses Contrastive pre-training, Self-Supervised Contrastive Learning using Random Feature (SCARF) Corruption approach, and the like.

Furthermore, in the case of semi-supervised learning, a predictive model is developed, which is also a deep neural network. The model is trained using labeled and unlabeled data that has been converted by the encoder in the semi-supervised stage of VIME. Therefore, so far, the VIME framework is the state-of-the-art self and semi-supervised tabular deep learning approach, which proposes a method for learning with limited labeled data.

However, these approaches suffer from limitations such as a lack of feature encoding which can help models to achieve higher prediction accuracy. Another limitation is prediction-based self-supervised tasks because there is a general move towards similarity (and dissimilarity) based contrastive and redundancy reduction tasks and away from predictive tasks in recent approaches, as the predictive tasks are generally inferior both theoretically and empirically. Yet another limitation includes a lack of Inductive Bias as the multi-layer perception does not carry any inductive biases in the architecture and has limited practical modeling capability.

Thus, there exists a technological need for technical solutions for training artificial intelligence (AI)-based models using limited labeled data.

### SUMMARY

Various embodiments of the present disclosure provide methods and systems for training artificial intelligence (AI)-based models using limited labeled data. The computer-implemented method performed by a server system includes accessing a tabular dataset from a database associated with the server system. The tabular dataset includes tabular data related to a plurality of entities. Herein, the tabular data includes labeled data and unlabeled data. Further, the computer-implemented method includes generating a set of labeled features based, at least in part, on the labeled data. Herein, the set of labeled features includes a set of labeled numerical features and a set of labeled categorical features. Further, the computer-implemented method includes generating a set of unlabeled features based, at least in part, on the unlabeled data. Herein, the set of unlabeled features includes a set of unlabeled numerical features and a set of unlabeled categorical features. Further, the computer-implemented method includes determining, via a first transformer model, a set of contextual numerical embeddings based, at least in part, on the set of labeled numerical features and the set of unlabeled numerical features. Further, the computer-implemented method includes determining, via a second transformer model, a set of contextual categorical embeddings based, at least in part, on the set of labeled categorical features and the set of unlabeled categorical features. Further, the computer-implemented method includes generating a set of concatenated embeddings based, at least in part, on concatenating the set of contextual numerical embeddings and the set of contextual categorical embeddings. Further, the computer-implemented method includes generating a third transformer model based, at least in part, on the set of concatenated embeddings.

In another embodiment, a server system is disclosed. The server system includes a communication interface and a memory including executable instructions. The server system also includes a processor communicably coupled to the memory. The processor is configured to execute the instructions to cause the server system, at least in part, to access a tabular dataset from a database associated with the server system. The tabular dataset includes tabular data related to a plurality of entities. Herein, the tabular data includes labeled data and unlabeled data. Further, the server system is caused to generate a set of labeled features based, at least in part, on the labeled data. Herein, the set of labeled features includes a set of labeled numerical features and a set of labeled categorical features. Further, the server system is caused to generate a set of unlabeled features based, at least in part, on the unlabeled data. Herein, the set of unlabeled features includes a set of unlabeled numerical features and a set of unlabeled categorical features. Further, the server system is caused to determine, via a first transformer model, a set of contextual numerical embeddings based, at least in part, on the set of labeled numerical features and the set of unlabeled numerical features. Further, the server system is caused to determine, via a second transformer model, a set of contextual categorical embeddings based, at least in part, on the set of labeled categorical features and the set of unlabeled categorical features. Further, the server system is caused to generate a set of concatenated embeddings based, at least in part, on concatenating the set of contextual numerical embeddings and the set of contextual categorical embeddings. Further, the server system is caused to generate a third transformer model based, at least in part, on the set of concatenated embeddings.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing a tabular dataset from a database associated with the server system. The tabular dataset includes tabular data related to a plurality of entities. Herein, the tabular data includes labeled data and unlabeled data. Further, the method includes generating a set of labeled features based, at least in part, on the labeled data. Herein, the set of labeled features includes a set of labeled numerical features and a set of labeled categorical features. Further, the method includes generating a set of unlabeled features based, at least in part, on the unlabeled data. Herein, the set of unlabeled features includes a set of unlabeled numerical features and a set of unlabeled categorical features. Further, the method includes determining, via a first transformer model, a set of contextual numerical embeddings based, at least in part, on the set of labeled numerical features and the set of unlabeled numerical features. Further, the method includes determining, via a second transformer model, a set of contextual categorical embeddings based, at least in part, on the set of labeled categorical features and the set of unlabeled categorical features. Further, the method includes generating a set of concatenated embeddings based, at least in part, on concatenating the set of contextual numerical embeddings and the set of contextual categorical embeddings. Further, the method includes generating a third transformer model based, at least in part, on the set of concatenated embeddings.

### BRIEF DESCRIPTION OF THE FIGURES

For a more complete understanding of example embodiments of the present technology, reference is now made to the following descriptions taken in connection with the accompanying drawings in which:

FIG. 1 illustrates an exemplary representation of an environment related to at least some example embodiments of the present disclosure;

FIG. 2 illustrates a simplified block diagram of a server system, in accordance with an embodiment of the present disclosure;

FIG. 3A illustrates a schematic representation of a self-supervised learning stage for training a transformer-based model, in accordance with an embodiment of the present disclosure;

FIG. 3B illustrates a schematic representation of a semi-supervised learning stage for training the transformer-based model, in accordance with an embodiment of the present disclosure;

FIG. 3C illustrates a schematic representation of an overall architecture of a hierarchical transformer-based model, in accordance with an example embodiment of the present disclosure;

FIG. 4 illustrates a schematic representation of an architecture used during a testing phase of the hierarchical transformer-based model and a prediction head for performing the prediction task, in accordance with an example embodiment of the present disclosure;

FIG. 5 illustrates a graphical representation of an effect of an amount of data on the performance of a neural architecture, in accordance with an embodiment of the present disclosure;

FIG. 6 illustrates a process flow diagram depicting a method for training an artificial intelligence (AI)-based model using limited labeled data, in accordance with an embodiment of the present disclosure.

FIG. 7A illustrates a process flow diagram depicting a method for training a first transformer model during the self-supervised learning stage, in accordance with an embodiment of the present disclosure;

FIG. 7B illustrates a process flow diagram depicting a method for training a second transformer model during the self-supervised learning stage, in accordance with an embodiment of the present disclosure;

FIG. 8A illustrates a process flow diagram depicting a method for training a first transformer model during the semi-supervised learning stage, in accordance with an embodiment of the present disclosure;

FIG. 8B illustrates a process flow diagram depicting a method for training a second transformer model during a semi-supervised learning stage, in accordance with an embodiment of the present disclosure; and

FIG. 9 illustrates a process flow diagram depicting a method for performing a prediction for a downstream task, in accordance with an embodiment of the present disclosure

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification does not necessarily all refer to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entirely hardware embodiment, an entirely software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

The terms “account holder”, “user”, “cardholder”, “consumer”, “buyer”, and “customer” are used interchangeably throughout the description and refer to a person who has a payment account or a payment card (e.g., credit card, debit card, etc.) associated with the payment account, that will be used by a merchant to perform a payment transaction. The payment account may be opened via an issuing bank or an issuer server.

The term “merchant”, used throughout the description generally refers to a seller, a retailer, a purchase location, an organization, or any other entity that is in the business of selling goods or providing services, and it can refer to either a single business location or a chain of business locations of the same entity.

The terms “payment network” and “card network” are used interchangeably throughout the description and refer to a network or collection of systems used for the transfer of funds through the use of cash substitutes. Payment networks may use a variety of different protocols and procedures in order to process the transfer of money for various types of transactions. Payment networks are companies that connect an issuing bank with an acquiring bank to facilitate an online payment. Transactions that may be performed via a payment network may include product or service purchases, credit purchases, debit transactions, fund transfers, account withdrawals, etc. Payment networks may be configured to perform transactions via cash substitutes that may include payment cards, letters of credit, checks, financial accounts, etc.

The term “payment card”, used throughout the description, refers to a physical or virtual card linked with a financial or payment account that may be presented to a merchant or any such facility to fund a financial transaction via the associated payment account. Examples of the payment card include, but are not limited to, debit cards, credit cards, prepaid cards, virtual payment numbers, virtual card numbers, forex cards, charge cards, e-wallet cards, and stored-value cards. A payment card may be a physical card that may be presented to the merchant for funding the payment. Alternatively, or additionally, the payment card may be embodied in the form of data stored in a user device, where the data is associated with a payment account such that the data can be used to process the financial transaction between the payment account and a merchant's financial account.

The term “payment account”, used throughout the description refers to a financial account that is used to fund a financial transaction. Examples of the financial account include, but are not limited to a savings account, a credit account, a checking account, and a virtual payment account. The financial account may be associated with an entity such as an individual person, a family, a commercial entity, a company, a corporation, a governmental entity, a non-profit organization, and the like. In some scenarios, the financial account may be a virtual or temporary payment account that can be mapped or linked to a primary financial account, such as those accounts managed by payment wallet service providers, and the like.

The terms “payment transaction”, “financial transaction”, “event”, and “transaction” are used interchangeably throughout the description and refer to a transaction of payment of a certain amount being initiated by the cardholder. More specifically, refers to electronic financial transactions including, for example, online payment, payment at a terminal (e.g., point of sale (POS) terminal), and the like. Generally, a payment transaction is performed between two entities, such as a buyer and a seller. It is to be noted that a payment transaction is followed by a payment transfer of a transaction amount (i.e., monetary value) from one entity (e.g., issuing bank associated with the buyer) to another entity (e.g., acquiring bank associated with the seller), in exchange of any goods or services.

### Overview

In an embodiment, the present disclosure describes a server system for training AI-based models using limited labeled data. The server system includes a processor and a memory. The server system is configured to access a tabular dataset (tabular data including labeled data and unlabeled data), generate a set of labeled features (labeled numerical features and labeled categorical features), and a set of unlabeled features (unlabeled numerical features and unlabeled categorical features), train an AI or ML model (a first transformer model for numerical features and a second transformer model for categorical features). Training includes a self-supervised learning stage and a semi-supervised learning stage. During each stage, distorted features are generated for both the labeled features and the unlabeled features. Then feature encoding is performed for generating embeddings for both the features and distorted features, i.e., labeled numerical embeddings and labeled categorical embeddings, distorted labeled numerical embeddings and distorted labeled categorical embeddings, unlabeled numerical embeddings and unlabeled categorical embeddings, distorted unlabeled numerical embeddings and distorted unlabeled categorical embeddings. The server system is further configured to generate contextual embeddings for both the numerical and categorical embeddings separately and then concatenated for generating a third transformer model which is used for effective mixing of the numerical features and the categorical features. Thus, a hierarchical transformer-based model (including the first transformer model, the second transformer model, and the third transformer model) is trained and fine-tuned and hence can be used to perform several tasks.

Various embodiments of the present disclosure offer multiple advantages and technical effects. For instance, the present disclosure is intended to utilize self-supervised learning and semi-supervised learning for training an AI or ML model for tabular data and limited labeled data. Moreover, the present disclosure is applicable for other types of datasets such as image, language, etc., however, in some cases, such datasets may have to be converted to tabular data prior to training the model for such datasets.

The present disclosure is capable of providing probabilistic estimates for predictive analysis and utilizes pretraining methods by use of self-supervised learning. The present disclosure is also capable of continual learning of streaming data with limited feature engineering required, and performing feature encoding helps the model to achieve higher prediction accuracy.

In addition, the splitting of the features into categorical and numerical, the generation of contextual embeddings for both separately by using the hierarchical encoder, and then effectively mixing using the same hierarchical model, reduces noise during data processing. It may be observed from the extensive experimentations conducted with reference to the present disclosure that the architecture indeed performs well in the less labeled data setting. Further, it is observed that pre-training and architecture matter the most. Intuitively, it is clear that barlow twins' redundancy loss enables the architecture to acquire meaningful representations and/or embeddings on unlabeled input, which is not possible with other approaches. Here, transformers also contribute a unique quality of being able to learn the inductive biases of the domain they are applied to. The total performance is also influenced by semi-supervised training and feature encoding.

In light of the tremendous success that self and semi-supervised learning frameworks have previously had in the domains of images and language, it may be observed that the proposed invention progresses towards these frameworks in the tabular domain. The present disclosure uses consistency-based training in the semi-supervised stage and negative sample-free redundancy reduction loss in the stage of self-supervised learning. On four publicly accessible tabular datasets in the less labeled data domain, state-of-the-art results are obtained when compared with existing baseline approaches.

Additionally, the model in the proposed disclosure is end-to-end trainable unlike VIME, a conventional method, where the encoder is fixed and not trainable during the semi-supervised phase, thereby making the proposed method more efficient and more flexible. Further, it may be noted that the aforementioned method achieves state-of-the-art (SOTA) results on common public tabular datasets in the less labeled data domain convincingly beating strong baselines like MLP, XgBoost, and VIME showcasing the efficacy of our approach.

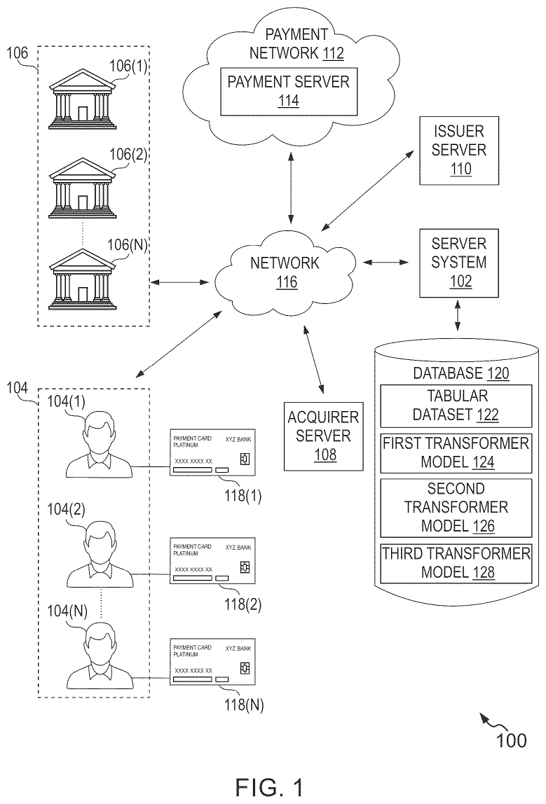

Various embodiments of the present disclosure are described hereinafter with reference to FIG. 1 to FIG. 9.

FIG. 1 illustrates an example representation of an environment 100 related to at least some embodiments of the present disclosure. Although the environment 100 is presented in one arrangement, other embodiments may include the parts of the environment 100 (or other parts) arranged otherwise depending on, for example, for training artificial intelligence (AI)-based models using limited labeled data.

The environment 100 generally includes a plurality of entities such as a server system 102, a plurality of cardholders 104(1), 104(2), . . . 104(N) (collectively, referred to cardholders 104 and ‘N’ is a Natural number), a plurality of merchants 106(1), 106(2), . . . 106(N) (collectively, referred to as merchants 106 and ‘N’ is a Natural number), an acquirer server 108, an issuer server 110, and a payment network 112 including a payment server 114, each coupled to, and in communication with (and/or with access to) a network 116. The network 116 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among two or more of the parts or users illustrated in FIG. 1, or any combination thereof.

Various entities in the environment 100 may connect to the network 116 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, future communication protocols or any combination thereof. For example, the network 116 may include multiple different networks, such as a private network made accessible by the server system 102 and a public network (e.g., the Internet, etc.) through which the server system 102, the acquirer server 108, the issuer server 110, and the payment server 114 may communicate.

In an embodiment, the cardholders 104 use one or more payment cards 118(1), 118(2), . . . 118(N) (collectively, referred to hereinafter payment cards 118 and ‘N’ is a Natural number) respectively to make payment transactions. The cardholder (e.g., the cardholder 104(1)) may be any individual, representative of a corporate entity, a non-profit organization, or any other person who is presenting payment account details during an electronic payment transaction. The cardholder (e.g., the cardholder 104(1)) may have a payment account issued by an issuing bank (not shown in figures) associated with the issuer server 110 (explained later) and may be provided a payment card (e.g., the payment card 118(1)) with financial or other account information encoded onto the payment card (e.g., the payment card 118(1)) such that the cardholder (i.e., the cardholder 104(1)) may use the payment card 118(1) to initiate and complete a payment transaction using a bank account at the issuing bank.

In an example, the cardholders 104 may use their corresponding electronic devices (not shown in figures) to access a mobile application or a website associated with the issuing bank, or any third-party payment application. In various non-limiting examples, the electronic devices may refer to any electronic devices such as, but not limited to, personal computers (PCs), tablet devices, Personal Digital Assistants (PDAs), voice-activated assistants, Virtual Reality (VR) devices, smartphones, and laptops.

The merchants 106 may include retail shops, restaurants, supermarkets or establishments, government and/or private agencies, or any such places equipped with POS terminals, where customers visit to perform financial transactions in exchange for any goods and/or services or any financial transactions.

In one scenario, the cardholders 104 may use their corresponding payment accounts to conduct payment transactions with the merchants 106. Moreover, it may be noted that each of the cardholders 104 may use their corresponding payment cards 118 differently or make the payment transaction using different means of payment. For instance, the cardholder 104(1) may enter payment account details on an electronic device (not shown) associated with the cardholder 104(1) to perform an online payment transaction. In another example, the cardholder 104(2) may utilize the payment card 118(2) to perform an offline payment transaction. It is understood that generally, the term “payment transaction” refers to an agreement that is carried out between a buyer and a seller to exchange goods or services in exchange for assets in the form of a payment (e.g., cash, fiat-currency, digital asset, cryptographic currency, coins, tokens, etc.). For example, the cardholder 104(3) may enter details of the payment card 118(3) to transfer funds in the form of fiat currency on an e-commerce platform to buy goods. In another instance, each cardholder of the cardholders 104 (e.g., the cardholder 104(1)) may transact at any merchant from the merchants 106 (e.g., the merchant 106(1)).

In one embodiment, the cardholders 104 is associated with the issuer server 110. In one embodiment, the issuer server is associated with a financial institution normally called an “issuer bank”, “issuing bank” or simply “issuer”, in which a cardholder (e.g., the cardholder 104(1)) may have the payment account, (which also issues a payment card, such as a credit card or a debit card), and provides microfinance banking services (e.g., payment transaction using credit/debit cards) for processing electronic payment transactions, to the cardholder (e.g., the cardholder 104(1)).

In an embodiment, the merchants 106 are associated with the acquirer server 108. In an embodiment, each merchant (e.g., the merchant 106(1)) is associated with an acquirer server (e.g., the acquirer server 108). In one embodiment, the acquirer server 108 is associated with a financial institution (e.g., a bank) that processes financial transactions. This can be an institution that facilitates the processing of payment transactions for physical stores, merchants (e.g., the merchants 106), or institutions that own platforms that make either online purchases or purchases made via software applications possible (e.g., shopping cart platform providers and in-app payment processing providers). The terms “acquirer”, “acquiring bank”, “acquiring bank” or “acquirer server” will be used interchangeably herein.

It may be known to any person skilled in the art that the transaction details or transaction history corresponding to the payment transactions that take place between the cardholders 104 and the merchants 106 may be recorded as tabular data. In a non-limiting example, the tabular data may include multiple rows corresponding to datapoints and multiple columns corresponding to attributes related to a particular datapoint. For instance, in the case of payment transactions, different transactions carried between various cardholders and various merchants may include a first transaction between a cardholder 104(1) and a merchant 106(1), a second transaction between a cardholder 104(2) and a merchant 106(2), and so on. Such transactions when recorded may be recorded and stored as a tabular record (known as tabular data) with each row indicating such transactions (the first transaction, the second transaction, and so on) and each column corresponds to attributes related to such payment transactions such as a transaction amount, a count of such transactions, a card type, a transaction type, merchant details, cardholder details, and the like.

As described earlier, apart from storing/recording transaction-related information, various other industries and applications such as healthcare, risk analysis, and the like store, record, or utilize data in tabular form, i.e., tabular data. Conventionally, tree-based ensemble models like gradient-boosted decision trees and the like are used to perform predictive analysis on the tabular data. Such tree-based models provide various advantages such as fast training, good accuracy, and interpretability. However, such models also suffer from a variety of limitations, such as, but not limited to, not being suitable for continual training from streaming data, unreliable probability estimation, heavy feature engineering, lack of usage of pre-training methods, poor handling of missing/noisy data, and the like.

It may also be noted that although the various embodiments of the present disclosure have been explained with respect to examples from the payment domain, the same should not be construed as a limitation. To that end, the various embodiments of the present disclosure can be applied to other suitable applications/domains as well with suitable modifications and the same would be covered within the scope of the present disclosure. For instance, for applications such as image processing or language processing, the image or language data may be converted to tabular data by applying suitable conversion techniques and then, the converted tabular data can be used for further processing.

As may be understood, tabular data generally includes labeled data and unlabeled data. However, it is generally seen that the unlabeled data makes up a majority of the tabular data while the labeled data generally forms a minority part, i.e., the labeled data is present in limited quantity. This is due to the fact that labeling of the tabular data is a complex, complicated, and a time taking process. In various examples, for applications such as Account Payment Capacity (APC) score evaluation in case of fraud detection in payment transactions, carbon footprint estimation, first-party fraud detection, and the like, the labeled data is generally very limited. It is noted that for training any Artificial intelligence (AI) or Machine Learning (ML) models, the labeled data is required. More specifically, if more labeled data is available during the training and testing process of the AI or ML models then, the performance of such models will be higher than those models which were trained on a lesser quantity of the labeled data. In other words, it is easier for the AI or ML models to learn using the labeled data. However, due to the abundance of unlabeled data, various conventional techniques have been developed to enable the AI or ML models to leverage the unlabeled data to learn insights or patterns to improve the performance of such models.

One such conventional technique includes a self-supervised learning model. In this, a variety of self-supervised tasks are used to acquire/learn meaningful representations from the unlabeled data. More specifically, challenges are made to be difficult yet pertinent to the end aim, which is to apply the acquired/learned knowledge to subsequent tasks. As the pretext model completes the self-supervised tasks, it learns by gleaning relevant information from the raw data. The predictive model then makes use of the obtained data in the subsequent tasks. Self-supervised learning often entails developing an encoder function (e: X→Z) that converts a sample of the input ‘X’ into a meaningful representation ‘Z’. To solve a self-supervised task, described by a pseudo-label, ‘yₛ’, and a self-supervised loss function, ‘lₛₛ’, the representation is optimized as indicated in Eqn.1.

$${min}_{e , h} {E}_{( x , y )} ∼ {pX}_{s} , {Y}_{s} [ {l}_{s s} ( {y}_{s} , ( h ∘ e ) ( {x}_{s} ) ) ] \qquad Eqn . 1$$

For example, the task might be to predict the rotation degree of an image, with the pseudo-label being the true rotation degree and the loss function being the squared difference between the prediction and the label. The pretext predictive model is trained along with the encoder function by minimizing the expected self-supervised loss. Predictive pretext tasks, which aim to predict data structure characteristics such as degree of rotation, jigsaw solution, the relative position of patches, etc., have increasingly given place to tasks that are contrastive or reduce redundancy. These tasks try to learn a notion of similarity (and dissimilarity) generally using an anchor and an augmented data point.

Furthermore, semi-supervised learning models are also used conventionally that improve the performance of the predictive model ‘f’ by reducing both the supervised loss and the unsupervised loss. This conventional approach combines both the supervised loss, which is based on given labels from the labeled data, and the unsupervised loss, which is based on the relationship between the outputs in the output space ‘Y’. This is achieved by introducing an unsupervised loss function, ‘lᵤ’, and a hyperparameter ‘β’ to balance the influence of both losses. The optimization problem in semi-supervised learning can be expressed by the Eqn. 2 given below, as a combination of the supervised loss and the unsupervised loss, where ‘\tilde{x}’ represents a slightly altered version of ‘x’.

$${min}_{f} {E}_{( x , y ) ∼ pX , Y} [ l ( y , f ( x ) ) ] + β \cdot {E}_{x ∼ pX , {x}^{′} ∼ \tilde{p} X ( {x}^{′} \vert x )} [ {l}_{u} ( f ( x ) , f ( {x}^{′} ) ] \qquad Eqn . 2$$

Further, such conventional methods may use a transformer-based model having two main components: a multi-head self-attention layer and a position-wise feed-forward layer. After each layer, there is an element-wise addition and layer-normalization step. The self-attention layer may include three matrices—Key, Query, and Value—which are used to project input embeddings into key, query, and value vectors. The attention head then calculates how much each input embedding attends to other embeddings. Thus, producing an attention matrix that transforms the input embedding into a contextual representation. The output of the attention head is then projected back to the original embedding dimension through a fully connected layer and two feed-forward layers, the first of which expands the embedding and the second of which reduces it back to its original size. In an example, Eqn. 3 (given below) defines the self-attention mechanism used in the transformer-based model.

$$Attention ( K , Q , V ) = A \cdot V \qquad Eqn . 3$$

$$where ,$$

$$A = softmax ( ( {QK}^{T} ) / \sqrt{k} )$$

Therefore, the explanations corresponding to self-supervised learning, semi-supervised learning, and the transformers may remain standard and when used individually for performing various tasks may not address the limitations mentioned earlier such as the lack of feature encoding, usage of prediction-based self-supervised tasks which are inferior both theoretically and empirically, the lack of inductive bias, and the like. Therefore, there exists a need to determine methods and systems for training AI-based models using limited labeled data while addressing the limitations or technical problems described earlier.

The above-mentioned technical problem among other problems is addressed by one or more embodiments implemented by the server system 102 of the present disclosure. In one embodiment, the server system 102 is configured to perform one or more of the operations described herein.

In one embodiment, the environment 100 may further include a database 120 coupled with the server system 102. In an example, the server system 102 coupled with the database 120 is embodied within the payment server 114, however, in other examples, the server system 102 can be a standalone component (acting as a hub) connected to the acquirer server 108 and the issuer server 110. The database 120 may be incorporated in the server system 102 or maybe an individual entity connected to the server system 102 or maybe a database stored in cloud storage or an independent entity communicably coupled with the server system 102. In one embodiment, the database 120 may be a central repository for storing data including a tabular dataset 122, various AI or ML models including a first transformer model 124, a second transformer model 126, a third transformer model 128, and other suitable data and/or algorithms required for the operation of the server system 102. In a non-limiting example, the tabular dataset 122 may include tabular data. The term ‘tabular dataset’ refers to a collection of related sets of information (for example, data related to a plurality of entities involved in the payment transactions with each other) that can be composed of different elements represented in tabular form but can be manipulated as a unit by a computer.

In various non-limiting examples, the database 120 may include one or more hard disk drives (HDD), solid-state drives (SSD), an Advanced Technology Attachment (ATA) adapter, a Serial ATA (SATA) adapter, a Small Computer System Interface (SCSI) adapter, a redundant array of independent disks (RAID) controller, a storage area network (SAN) adapter, a network adapter, and/or any component providing the server system 102 with access to the database 120. In one implementation, the database 120 may be viewed, accessed, amended, updated, and/or deleted by an administrator (not shown) associated with the server system 102 through a database management system (DBMS) or relational database management system (RDBMS) present within the database 120.

In other various examples, the database 120 may also include multifarious data, for example, data related to various tasks/applications for which the AI or ML models such as the first transformer model 124, the second transformer model 126, and the third transformer model 128 have to be trained and tested. Therefore, it is noted that the data included in the database 120 may be different based on the task or application for which the server system 102 is implementing the training, testing, and operating process.

In a non-limiting example, the tabular dataset 122 may include transaction attributes, such as transaction amount, cardholder identifier (ID), merchant ID, cardholder product type, cardholder country name, cardholder city name, merchant type, Merchant category code (MCC), merchant location, merchant industry type, merchant super category code, transaction location information, transaction channel information, source of funds information such as bank or credit cards, cardholder issuer ID, merchant acquirer ID, risk scores, cardholder Permanent Account Number (PAN), etc., among other data related to a transaction between a merchant and a cardholder. In addition, the database 120 provides a storage location for data and/or metadata obtained from various operations performed by the server system 102.

In an embodiment, the server system 102 is configured to access the tabular dataset 122 from the database 120 associated with the server system 102. In some embodiments, the tabular dataset 122 includes tabular data related to a plurality of entities. For instance, datapoints corresponding to the plurality of entities may include data related to payment transactions, medical records corresponding to the diagnosis of patients, investment-related data, individual classification-related data, and the like based on the application for which the AI or ML models have to be trained. As mentioned earlier, herein, the application taken as an example for the sake of explanation is considered to be in the financial domain. In other words, data related to payment transactions between the cardholders 104 and the merchants 106 is used herein as an example of the tabular data 122. However, it is noted that the same should not be construed as a limitation of the present disclosure and other types of tabular data are also covered within the scope of the present disclosure.

It is noted that tabular data related to the transactions between different entities can be broadly classified into numerical data and categorical data. Now, the tabular data (and each of these categories of data, i.e., numerical and categorical) can also be either labeled or unlabeled. Thus, it may be broadly said that tabular data includes labeled data and unlabeled data. As may be understood, both the labeled data and the unlabeled data will include their set of corresponding numerical data and set of corresponding categorical data.

The server system 102 may further be configured to generate a set of labeled features (hereinafter, interchangeably referred to as ‘labeled features’) based, at least in part, on the labeled data. It is understood that the term ‘labeled features’ is used herein to refer to those features that are generated using or by leveraging the labeled data. Now, since the labeled data further includes the set of corresponding numerical data and the set of corresponding categorical data that are labeled therefore, the thus generated labeled features may include a set of labeled numerical features and a set of labeled categorical features. The labeled features can be converted to feature representations (i.e., embeddings) including the corresponding feature representations of the set of corresponding numerical features and the set of corresponding categorical features (i.e., numerical embeddings and categorical embeddings). In various non-limiting examples, the numerical features related to the merchants 106 may include at least average ticket price, total sales volume, an average spent per card, for the last 1 week, 1 month, 3 months, and the like. Similarly, in various non-limiting examples, the categorical features related to the merchants 106 may include merchant co-ordinates (i.e., latitude and longitude of the merchant), merchant industry, merchant super-industry, Merchant Category Code (MCC), and the like. It should be understood that numerical and categorical features pertaining to each of the plurality of entities depicted in FIG. 1 may be different from each other and merchant-related features are just provided herein as an example.

Further, the server system 102 may be configured to generate a set of unlabeled features (hereinafter, interchangeably referred to as ‘unlabeled features’) based, at least in part, on the unlabeled data. The unlabeled features may include a set of unlabeled numerical features and a set of unlabeled categorical features. It is noted that this process is similar to the process described earlier, therefore the same is not explained again for the sake of brevity.

Furthermore, the server system 102 may be configured to train an AI or ML model based, at least in part, on the labeled features and the unlabeled features. In particular, the server system 102 is configured to train the first transformer model 124 based, at least in part, on the set of labeled numerical features and the set of unlabeled numerical features. Similarly, the server system 102 is configured to train the second transformer model 126 based, at least in part, on the set of labeled categorical features and the set of unlabeled categorical features.

Herein, both the first transformer model 124 and the second transformer model 126 are configured to perform a self-supervised learning stage and a semi-supervised learning stage.

For instance, for training the first transformer model 124 during the self-supervised learning stage, the server system 102 is configured to perform a set of operations. The set of operations includes at first, the server system 102 configured to generate a set of distorted unlabeled numerical features based, at least in part, on the set of unlabeled numerical features. In a non-limiting example, the server system 102 may be configured to generate the set of distorted unlabeled numerical features by performing marginal distortion on a first subset of unlabeled numerical features of the set of unlabeled numerical features. Therefore, the remaining features of the set of unlabeled numerical features may now be referred to as a second subset of unlabeled numerical features including undistorted unlabeled numerical features.

Then, the server system 102 is configured to generate a set of labeled numerical embeddings and a set of unlabeled numerical embeddings based, at least in part, on the set of labeled numerical features and the set of unlabeled numerical features respectively. Further, the server system 102 is configured to generate a set of distorted unlabeled numerical embeddings based, at least in part, on the distorted unlabeled numerical features. In various non-limiting examples, the encoding of features into ‘feature representations’ or ‘embeddings’ is achieved using a variety of techniques such as one-hot encoding, entity encoding, and the like.

Thereafter, the server system 102 may further be configured to generate a first set of contextual numerical embeddings based, at least in part, on the set of unlabeled numerical embeddings. Similarly, the server system 102 may be configured to generate a second set of contextual numerical embeddings based, at least in part, on the set of distorted unlabeled numerical embeddings.

As may be understood, since contextual embeddings (the first set of contextual numerical embeddings and the second set of contextual numerical embeddings) are generated using the unlabeled numerical embeddings and the distorted unlabeled numerical embeddings, the context or the learning derived from these different embeddings must be similar to each other. It is noted that understanding/inference/learning gained from two embeddings that have the same origin must be similar as well. For instance, an inference drawn from a numerical embedding indicating a numerical feature corresponding to a gross dollar value (GDV) of transactions performed in 1 month=$100 for a particular merchant should be similar to an inference drawn from a distorted numerical embedding indicating to a numerical feature (now distorted) corresponding to GDV of 1 month=$102 for the same merchant. Therefore, it is understood that there should not be a difference between inferences drawn from the set of unlabeled numerical embedding and its corresponding set of distorted unlabeled numerical embedding. In other words, the difference between each of the first set of contextual numerical embeddings corresponding to the set of unlabeled numerical embeddings and the second set of contextual numerical embeddings generated using the set of distorted unlabeled numerical embeddings should be minimal. To achieve this, the server system 102 may be configured to compute a self-supervised loss by comparing the first set of contextual numerical embeddings with the second set of contextual numerical embeddings.

Upon computing the self-supervised loss, the self-supervised loss may have to be reduced to achieve the above-mentioned objective. Therefore, the server system 102 may be further configured to fine-tune the first transformer model 124 based, at least in part, on the self-supervised loss. It is noted that the fine-tuning process of the first transformer model 124 includes adjusting weights associated with the layers of the first transformer model 124. Further, in an embodiment, this process of adjusting the weights based on the self-supervised loss is repeated iteratively until the self-supervised loss becomes nearly nil (zero). When the self-supervised loss is minimized (i.e., it becomes nearly zero), the training process moves to the semi-supervised learning stage.

During the semi-supervised learning stage, the server system 102 is configured to perform another set of operations. The another set of operations includes first, the server system 102 configured to generate a set of distorted labeled numerical embeddings based, at least in part, on the set of labeled numerical embeddings. In a non-limiting example, the server system 102 may be configured to generate the set of distorted labeled numerical embeddings by performing the marginal distortion on a first subset of labeled numerical embeddings of the set of labeled numerical embeddings. Therefore, the remaining embeddings of the set of labeled numerical embeddings may now be referred to as a second subset of labeled numerical embeddings including undistorted labeled numerical embeddings.

The server system 102 may further be configured to generate a third set of contextual numerical embeddings based, at least in part, on the set of labeled numerical embeddings and the set of unlabeled numerical embeddings. The server system 102 may further be configured to generate a fourth set of contextual numerical embeddings based, at least in part, on the set of distorted labeled numerical embeddings and the set of distorted unlabeled numerical embeddings.

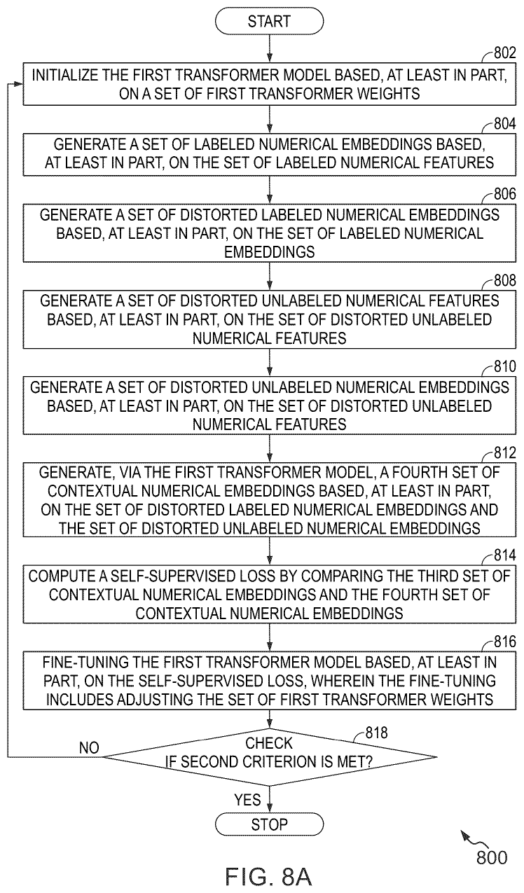

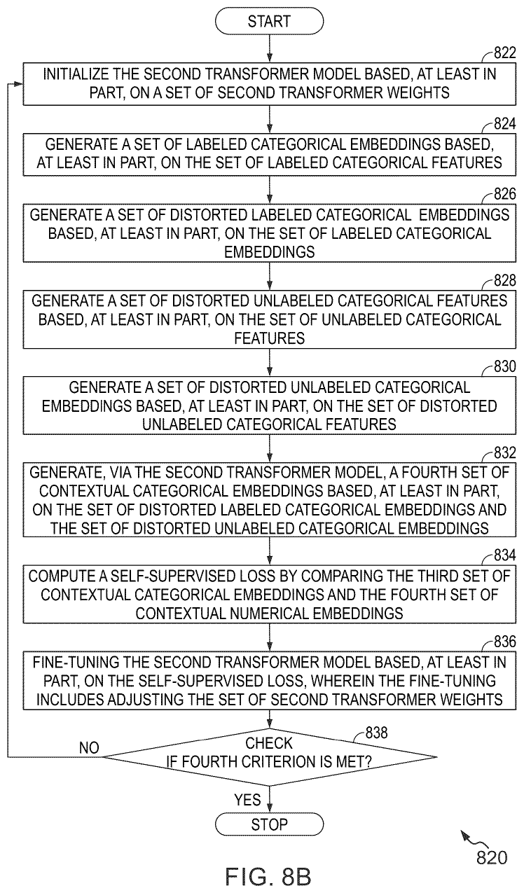

As described with reference to the self-supervised learning stage, the loss calculation is repeated in the semi-supervised learning stage for the corresponding contextual embeddings. This process is similar to the one described earlier, therefore it is not repeated again herein, for the sake of brevity. The steps are clearly disclosed in the description of FIG. 8A and FIG. 8B. To that end, the server system 102 may be configured to compute a semi-supervised loss by comparing the third set of contextual numerical embeddings and the fourth set of contextual numerical embeddings. Further, the server system 102 is configured to fine-tune (rather re-tune) the first transformer model 124 based, at least in part, on the semi-supervised loss. It is noted that the fine-tuning process of the first transformer model 124 includes adjusting (rather readjusting) the weights associated with the layers of the first transformer model 124. Further, this process of adjusting the weights based on the semi-supervised loss is repeated iteratively until the semi-supervised loss becomes nearly nil (zero). When the semi-supervised loss is minimized (i.e., it becomes nearly zero), the training process is completed.

Now, once the training process of the first transformer model 124 is completed, the server system 102 is configured to generate via the first transformer model 124 (now, trained), a set of contextual numerical embeddings based, at least in part, on the set of labeled numerical features and the set of unlabeled numerical features.

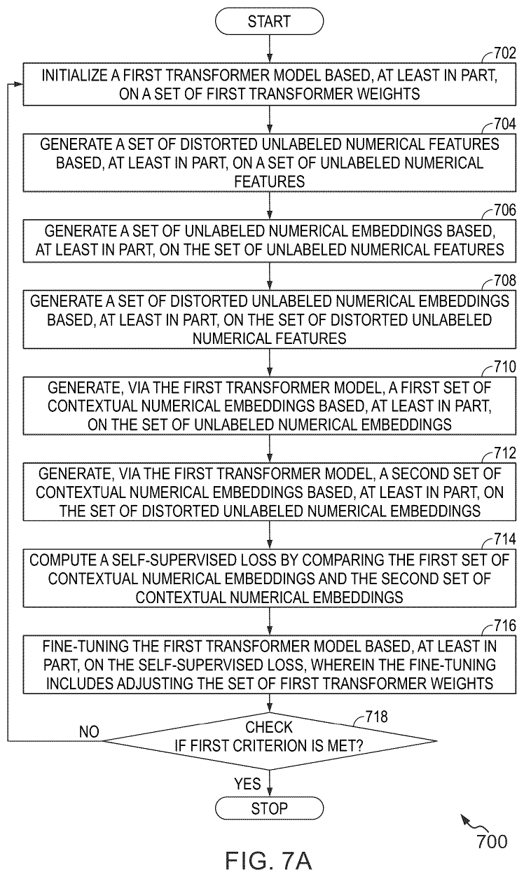

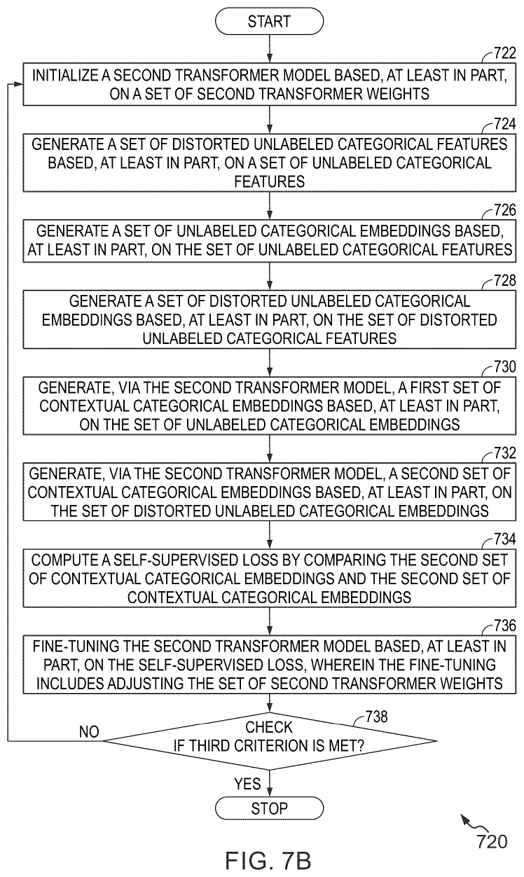

It is noted that the training process of the second transformer model 126 is similar to the training process described with reference to the first transformer model 124 earlier. As may be understood, the second transformer model 126 simply trains using categorical features as an input and generates results corresponding to the set of categorical features instead of the set of numerical features. Therefore, the same training process is not described again for the sake of brevity. However, the training process for the set of categorical features is disclosed with reference to FIG. 7B and FIG. 8B.

Once, the training process of the second transformer model 126 is completed, the server system 102 is configured to generate via the second transformer model 126 (now, trained), a set of contextual categorical embeddings based, at least in part, on the set of labeled categorical features and the set of unlabeled categorical features.

In another embodiment, the server system 102 may further be configured to generate a set of concatenated embeddings based, at least in part, on concatenating the set of contextual numerical embeddings and the set of contextual categorical embeddings. Furthermore, the server system 102 may be configured to generate a new AI or ML model based, at least in part, on the set of concatenated embeddings. In particular, the server system 102 may be configured to generate the third transformer model 128 based, at least in part, on the set of concatenated embeddings.

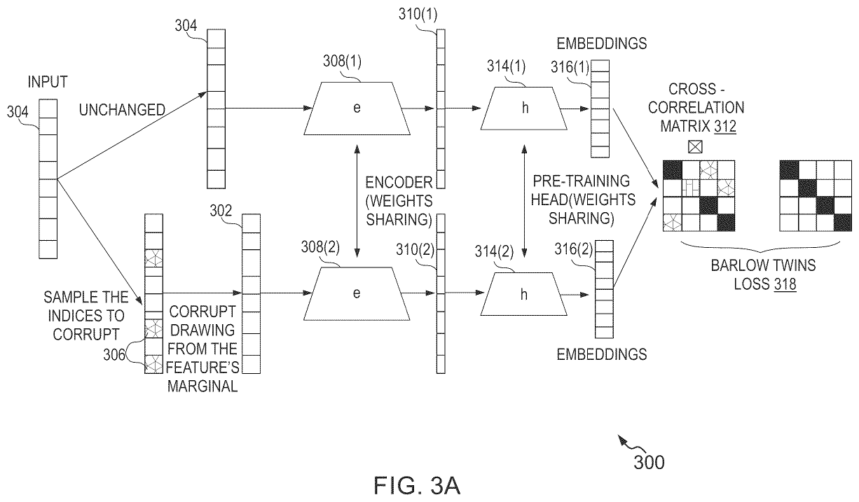

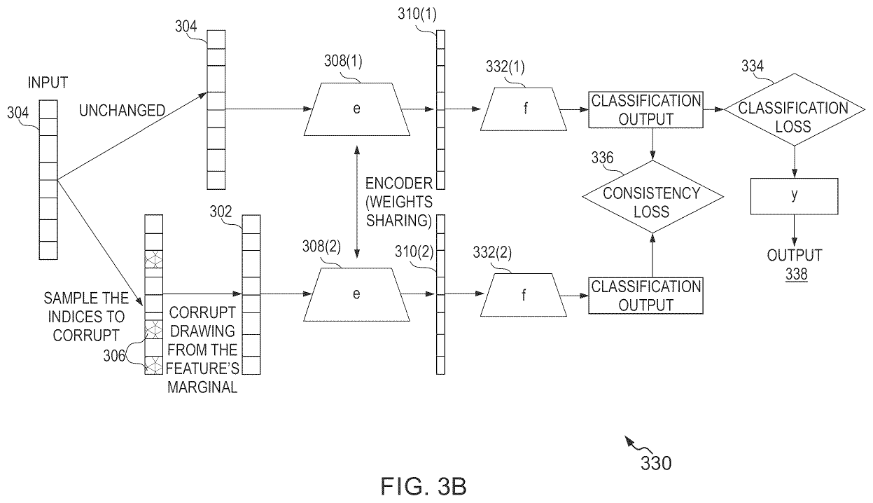

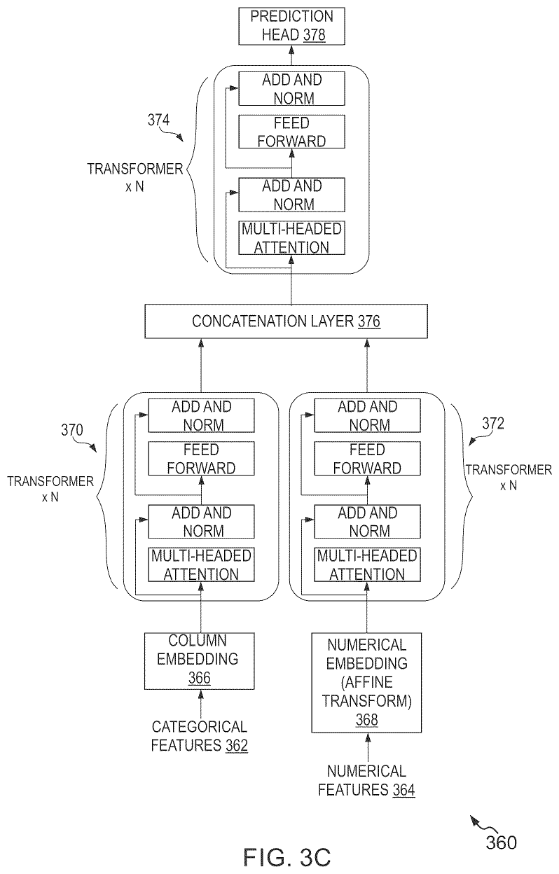

It may be noted that the generation process including the training and learning process of the first transformer model 124, the second transformer model 126, and the third transformer model 128 have been explained further in detail later in the present disclosure with reference to FIG. 3A to FIG. 3C.

In one embodiment, the payment network 112 may be used by the payment card issuing authorities as a payment interchange network. Examples of the payment cards 118 include debit cards, credit cards, etc. It should be understood that the server system 102 is a separate part of the environment 100, and may operate apart from (but still in communication with, for example, via the network 116) any third-party external servers (to access data to perform the various operations described herein). However, in other embodiments, the server system 102 may be incorporated, in whole or in part, into one or more parts of the environment 100.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 116, which may be specifically configured, via executable instructions, to perform steps as described herein, and/or embodied in at least one non-transitory computer-readable media.

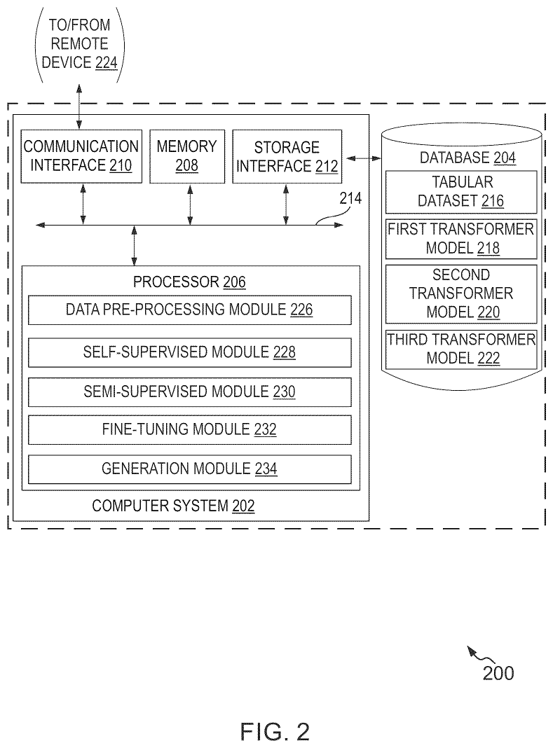

FIG. 2 illustrates a simplified block diagram of a server system 200, in accordance with an embodiment of the present disclosure. The server system 200 is identical to the server system 102 of FIG. 1. In one embodiment, the server system 200 is a part of the payment network 112 or integrated within the payment server 114. In some embodiments, the server system 200 is embodied as a cloud-based and/or SaaS-based (software as a service) architecture.

The server system 200 includes a computer system 202 and a database 204. The computer system 202 includes at least one processor 206 for executing instructions, a memory 208, a communication interface 210, and a storage interface 212 that communicates with each other via a bus 214.

In some embodiments, the database 204 is integrated into the computer system 202. For example, the computer system 202 may include one or more hard disk drives as the database 204. A storage interface 212 is any component capable of providing the processor 206 with access to the database 204. The storage interface 212 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one non-limiting example, the database 204 is configured to store a tabular dataset 216, a first transformer model 218, a second transformer model 220, a third transformer model 222, and the like. In one embodiment, the database 204 is substantially similar to the database 120 of FIG. 1. Thus, it is noted that the tabular dataset 216, the first transformer model 218, the second transformer model 220, and the third transformer model 222 are identical to the tabular dataset 122, the first transformer model 124, the second transformer model 126, and the third transformer model 128 of FIG. 1.

The processor 206 includes suitable logic, circuitry, and/or interfaces to execute operations for training artificial intelligence (AI)-based models using limited labeled data. Examples of the processor 206 include, but are not limited to, an application-specific integrated circuit (ASIC) processor, a reduced instruction set computing (RISC) processor, a graphical processing unit (GPU), a complex instruction set computing (CISC) processor, a field-programmable gate array (FPGA), and the like.

The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device 224 such as the acquirer server 108, the issuer server 110, the payment server 114, or communicating with any entity connected to the network 116 (as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a data pre-processing module 226, a self-supervised module 228, a semi-supervised module 230, a fine-tuning module 232, and a generation module 234. It should be noted that components, described herein, such as the data pre-processing module 226, the self-supervised module 228, the semi-supervised module 230, the fine-tuning module 232, and the generation module 234 can be configured in a variety of ways, including electronic circuitries, digital arithmetic, and logic blocks, and memory systems in combination with software, firmware, and embedded technologies. Moreover, it may be noted that the data pre-processing module 226, the self-supervised module 228, the semi-supervised module 230, the fine-tuning module 232, and the generation module 234 may be communicably coupled with each other to exchange information with each other for performing the one or more operations facilitated by the server system 200.

In an embodiment, the data pre-processing module 226 includes suitable logic and/or interfaces for accessing the tabular dataset 216 from the database 204 associated with the server system 200. The tabular dataset 216 may include tabular data related to a plurality of entities. For instance, an entity of the plurality of entities may include the payment transactions. Thus, the tabular data may be related to the payment transactions performed by a merchant, a cardholder, etc.

It is noted that the tabular data can be broadly classified into numerical data and categorical data. Further, the tabular data can also be either labeled or unlabeled. Thus, it may be broadly said that tabular data includes labeled data and unlabeled data. As may be understood, both the labeled data and the unlabeled data will include their set of corresponding numerical data and set of corresponding categorical data.

In addition, the data pre-processing module 226 is configured to generate a set of labeled features based, at least in part, on the labeled data. The set of labeled features may include a set of labeled numerical features and a set of labeled categorical features. Further, the data pre-processing module 226 is configured to generate a set of unlabeled features based, at least in part, on the unlabeled data. The set of unlabeled features may include a set of unlabeled numerical features and a set of unlabeled categorical features. This is then fed to the self-supervised module 228 and the semi-supervised module 230 for the training of an AI or ML model (e.g., the first transformer model 218, the second transformer model 220, and the third transformer model) at a self-supervised learning stage which is followed by a semi-supervised learning stage.

Therefore, the self-supervised module 228 includes suitable logic and/or interfaces for training the first transformer model 218 based, at least in part, on the set of labeled numerical features and the set of unlabeled numerical features. The self-supervised module 228 is configured to perform a set of operations during the self-supervised learning stage. The set of operations may include at least one of: (i) generating a set of distorted unlabeled features based, at least in part, on the set of unlabeled features, (ii) generating a set of unlabeled numerical features from the set of unlabeled features, (iii) extracting a set of distorted unlabeled numerical features from the set of distorted unlabeled features, (iv) generating a set of unlabeled numerical embeddings and a set of distorted unlabeled numerical embeddings based, at least in part, on the set of unlabeled numerical features and the set of distorted unlabeled numerical features respectively, (v) generating a first set of contextual numerical embeddings based, at least in part, on the set of unlabeled numerical embeddings, (vi) generating a second set of contextual numerical embeddings based, at least in part, on the set of distorted unlabeled numerical embeddings, (vii) generating a self-supervised loss by comparing the first set of contextual numerical embeddings and the second set of contextual numerical embeddings, and (viii) fine-tuning the first transformer model 218 based, at least in part, on the self-supervised loss.

In some embodiments, the fine-tuning module 232 may include suitable logic and/or interfaces for performing the steps of generating the self-supervised loss by comparing the first set of contextual numerical embeddings and the second set of contextual numerical embeddings, and fine-tuning the first transformer model 218 based, at least in part, on the self-supervised loss. The self-supervised module 228 may receive output (the first transformer model 218 that is fine-tuned) from the fine-tuning module 232, thereby completing the process of training the first transformer model 218 during the self-supervised learning stage.

The self-supervised module 228 is further configured to train the second transformer model 220 based, at least in part, on the set of labeled categorical features and the set of unlabeled categorical features. The self-supervised module 228 is configured to perform a set of operations during the self-supervised learning stage for the set of categorical features similar to the steps performed for the set of numerical embeddings and hence are not repeated here for the sake of brevity. Moreover, these steps are disclosed in detail with reference to FIG. 7B later in the present disclosure.

Further, the semi-supervised module 230 includes suitable logic and/or interfaces for training the first transformer model 218 based, at least in part, on the set of labeled numerical features and the set of unlabeled numerical features. The semi-supervised module 230 is configured to perform another set of operations during the semi-supervised learning stage. The set of operations may include at least one of: (i) generating a set of distorted labeled numerical embeddings based, at least in part, on the set of labeled numerical embeddings, (ii) generating a third set of contextual numerical embeddings based, at least in part, on the set of labeled numerical embeddings and the set of unlabeled numerical embeddings, (iii) generating a fourth set of contextual numerical embeddings based, at least in part, on the set of distorted labeled numerical embeddings and the set of distorted unlabeled numerical embeddings, (iv) computing a semi-supervised loss by comparing the third set of contextual numerical embeddings and the fourth set of contextual numerical embeddings, and (v) fine-tuning the first transformer model 218 based, at least in part, on the semi-supervised loss.

In some embodiments, the fine-tuning module 232 may be configured to perform the steps of computing the semi-supervised loss by comparing the third set of contextual numerical embeddings and the fourth set of contextual numerical embeddings, and fine-tuning the first transformer model 218 based, at least in part, on the semi-supervised loss. The semi-supervised module 230 may receive output (the first transformer model 218 that is fine-tuned) from the fine-tuning module 232, thereby completing the process of training the first transformer model 218 during the semi-supervised learning stage.

The semi-supervised module 230 is further configured to train the second transformer model 220 based, at least in part, on the set of labeled categorical features and the set of unlabeled categorical features. The semi-supervised module 230 is configured to perform a set of operations during the semi-supervised learning stage for the set of categorical features similar to the steps performed for the set of numerical embeddings and hence are not repeated here for the sake of brevity. Moreover, these steps are disclosed in detail with reference to FIG. 8B later in the present disclosure.

In a non-limiting example, the first transformer model 218 may include a first encoder head and the second transformer model 220 may include a second encoder head.

Fine-tuning the first transformer model 218 may correspond to reducing the distance between the third set of contextual numerical embeddings and the fourth set of contextual numerical embeddings. Upon fine-tuning, the difference between the third set of contextual numerical embeddings and the fourth set of contextual numerical embeddings may get nearer to zero.

Similarly, fine-tuning the second transformer model 220 may correspond to reducing the distance between the third set of contextual categorical embeddings and the fourth set of contextual categorical embeddings. Upon fine-tuning, the difference between the third set of contextual categorical embeddings and the fourth set of contextual categorical embeddings may get nearer to zero.

Further, the first transformer model 218 and the second transformer model 220 are provided to the generation module 234. Additionally, the set of contextual numerical embeddings and the set of contextual categorical embeddings are fed to the generation module 234. The generation module 234 includes suitable logic and/or interfaces for generating via the first transformer model 218, a set of contextual numerical embeddings based, at least in part, on the set of labeled numerical features and the set of unlabeled numerical features. The generation module 234 may further be configured to generate via the second transformer model 220, a set of contextual categorical embeddings based, at least in part, on the set of labeled categorical features and the set of unlabeled categorical features. Further, the generation module 234 may be configured to generate a set of concatenated embeddings based, at least in part, on concatenating the set of contextual numerical embeddings and the set of contextual categorical embeddings.

The generation module 234 is further configured to generate a third ML model such as the third transformer model 222 based, at least in part, on the set of concatenated embeddings.

In a non-limiting example, a hierarchical transformer-based model is obtained including the first transformer model 218, the second transformer model 220, and the third transformer model 222, that may be used to perform task-specific operations such as prediction of a transaction being a fraud when used with a prediction head. Alternatively, the hierarchical transformer-based model may be used for any other application such as the diagnosis of a medical condition of a patient, investment estimation, portfolio enhancement, and the like.

FIG. 3A illustrates a schematic representation of the self-supervised learning stage 300 for training a transformer-based model (e.g., the first transformer model 124 and the second transformer model 126) in accordance with an embodiment of the present disclosure. In various embodiments, during the self-supervised learning stage 300, a variety of operations are performed by the server system 200. In a non-limiting example, the variety of operations may include at least: (1) feature distortion, (2) contextual feature encoding, (3) transformer encoder, and (4) redundancy reduction.

In a non-limiting implementation, the server system 200 begins the training process by generating a set of distorted unlabeled features based, at least in part, on the set of unlabeled features. For instance, the step of generating the set of distorted unlabeled features (called ‘step of feature distortion’) includes creating a distorted version 302 of an input 304 say ‘x’, which may be indicated as ‘k’. Herein, the input 304 corresponds to the set of unlabeled features. Further, the server system 200 may randomly select a portion 306 of the features corresponding to the input ‘x’ 304. Herein, the portion 306 refers to a first subset of unlabeled features. Then, the server system 200 replaces the features corresponding to the portion 306 with values randomly chosen from their marginal distribution. Herein, the term ‘marginal distribution’ refers to a uniform distribution of all the values that the feature has in the tabular dataset 122.

Thereafter, the server system 200 is configured to split or extract the features into numerical features and categorical features. Further, the corresponding features are encoded for generating corresponding embeddings. In a non-limiting example, the categorical features ‘xi’ are transformed into a dimensional embedding of ‘d’ through column embedding. This process is repeated for labeled categorical features, unlabeled categorical features, and distorted categorical features for generating labeled categorical embeddings, unlabeled categorical embeddings, and distorted categorical embeddings. Further, for each numerical feature, the server system 200 may apply an affine transform to create a corresponding high-dimensional numerical embedding. This process is repeated for labeled numerical features, unlabeled numerical features, and distorted numerical features to generate labeled numerical embeddings, unlabeled numerical embeddings, and distorted numerical embeddings.

Thereafter, the server system 200 is configured to generate a first set of contextual numerical embeddings based, at least in part, on the set of unlabeled numerical embeddings. Similarly, the server system 200 is configured to generate a first set of contextual categorical embeddings based, at least in part, on the set of unlabeled categorical embeddings. Further, the server system 200 is configured to generate a second set of contextual numerical embeddings based, at least in part, on the set of distorted numerical embeddings. Similarly, the server system 200 is configured to generate a second set of contextual categorical embeddings based, at least in part, on the set of distorted categorical embeddings. In a particular implementation, the categorical embeddings are passed through a transformer which learns contextual embeddings for them, a similar process is followed for numerical embeddings. At this stage, the server system 200 may provide contextual embeddings for both the categorical and numerical features.

Further, in some embodiments, a hierarchical transformer-based model may be used that has an encoder ‘e’ (e.g., a first encoder 308(1) and a second encoder 308(2)) that enables or facilitates effective feature mixing among the numerical features (or numerical encodings) and categorical features (or categorical encodings). The server system 200 may generate contextual feature encodings (i.e., contextual embeddings) and pass them through the encoder (N layer transformer). In a non-limiting example, the server system 200 may use a pre-norm type of transformer which has been shown to be easier to optimize and train effectively on small datasets.

In another implementation, the overall architecture of the hierarchical transformer-based model may further include three separate models, i.e., the first transformer model 124, the second transformer model 126, and the third transformer model 128. Each of these models may perform the tasks of the hierarchical transformer-based model separately. For instance, the first transformer model 124 may generate contextual feature encodings (i.e., contextual embeddings) based on the numerical features. Further, the second transformer model 126 may generate contextual feature encodings (i.e., contextual embeddings) based on the categorical features. Furthermore, the third transformer model 128 may generate a prediction result by effectively mixing or concatenating the output of the first transformer model 124 (i.e., the set of contextual numerical embeddings) and the second transformer model 126 (i.e., the set of contextual categorical embeddings).

Additionally, the server system 200 may perform the step of redundancy reduction for the hierarchical transformer-based model or each of the individual models, i.e., the first transformer model 124, the second transformer model 126, and the third transformer model 128. In an embodiment, a loss function that does not require negative samples for training the encoder network may be considered by the server system 200. The loss function may be defined as ‘self-supervised loss’. As described earlier, the self-supervised loss has to be minimized. This is done by fine-tuning the hierarchical transformer-based model (the first transformer model 124 or the second transformer model 126) based, at least in part, on the self-supervised loss. In particular, for implementing the fine-tuning process, at first, the server system 200 may initialize the process by normalizing embedding matrices such as ‘z₁’ and ‘z₂’ along the batch dimension, with a mean of zero and a standard deviation of one. Then, the server system 200 may calculate an empirical cross-correlation matrix ‘c’ 312 using the batch indexes (b) and the indexes of embeddings (i, j). This setting is called Barlow Twins and has been developed based on the redundancy-reduction principle proposed by neuroscientist H. Barlow. The cross-correlation matrix is computed using Eqn.4.

$${c}_{ij} = \frac{{\sum }_{b} {z}_{b , i}^{( 1 )} {z}_{b , j}^{( 2 )}}{\sqrt{{( {\sum }_{b} {z}_{b , i}^{( 1 )} )}^{2}} \sqrt{{( {\sum }_{b} {z}_{b , j}^{( 2 )} )}^{2}}} \qquad Eqn . 4$$

Conventionally, this method may be used to develop self-supervised image representation learning systems. In such methods, the cross-correlation matrix ‘c’ is optimized to produce the identity matrix using the Barlow twin's loss function (l_{BT}). The loss is divided into two parts: (I) the invariance term, which makes the off-diagonal elements of ‘c’ equal to zero and guarantees that the embeddings are invariant to augmentations (distortions); and (II) the redundancy reduction term, which reduces the off-diagonal elements to zero and produces uncorrelated components of the embeddings. When maximizing the total loss, the parameter ‘λ’ (with λ>0) controls how the invariance and redundancy reduction terms are balanced. To get the optimal λ value for a particular experiment, the methods may use a grid search.

The gradient is symmetrically back propagated through the encoder network ‘e’ (e.g., the encoder 308(1) and 308(2)) and a projector network ‘h’ (e.g., the projector network ‘h’ 314(1) and 314(2) as shown in FIG. 3A) which is used for reducing the dimensionality of the encoder features (e.g., the contextual encoding 310(1) and 310(2)) and generating contextual embeddings 316(1) and 316(2) with reduced dimensionality. Therefore, the encoder network ‘e’ may not rely on special techniques such as momentum encoders, gradient stopping, or predictor networks. As may be understood, by back-propagating the gradient (i.e., self-supervised loss), the model is fine-tuned and a Barlow twin's loss 318 is computed using Eqn.5.

$${l}_{BT} = {\sum }_{i} {( 1 - {c}_{ii} )}^{2} + λ {\sum }_{i} {\sum }_{j \neq i} {c}_{ij}^{2} \qquad Eqn . 5$$

FIG. 3B illustrates a schematic representation of the semi-supervised learning stage 330 for training the transformer-based model (e.g., the first transformer model 124 and the second transformer model 126), in accordance with an embodiment of the present disclosure. In an embodiment, the usage of encoder ‘e’ 308(1) and 308(2) in the semi-supervised learning stage 330 may be explained with reference to FIG. 3B. As may be understood, upon completion of the self-supervised learning stage 300, the encoder of the hierarchical transformer-based model (the first transformer model 124 or the second transformer model 126) is further trained using the semi-supervised learning stage 330.

The server system 200 is configured to generate a set of distorted labeled numerical embeddings based, at least in part, on the set of labeled numerical embeddings. A similar process has been explained earlier with reference to FIG. 3A, therefore the explanation is not repeated again for the sake of brevity. Further, the server system 200 is configured to generate a third set of contextual numerical embeddings based, at least in part, on the set of labeled numerical embeddings and the set of unlabeled numerical embeddings. Further, the server system 200 may further be configured to generate a fourth set of contextual numerical embeddings based, at least in part, on the set of distorted labeled numerical embeddings and the set of distorted unlabeled numerical embeddings.

For instance, by combining ‘J’ 332(1) (‘J’ 332(2)) and ‘e’ 308(1) (‘e’ 308(2)), the server system 200 may produce a function ‘fₑ’. Further, ‘ŷ’ may be the same as the function ‘fₑ’ applied to the input ‘x’ 304 (i.e., the set of labeled numerical embeddings and the set of unlabeled numerical embeddings). By minimizing an objective function “final” which is the total of a supervised loss ‘lₛ’ 334 (also referred to as ‘classification loss 334’) and a consistency loss ‘lᵤ’ 336, weighted by beta (p), the server system 200 may train the predictive model ‘J’. The supervised loss ‘lₛ’ 334 may be computed using the standard loss function (e.g., mean squared error for regression or categorical cross-entropy for classification) between the true labels ‘y’ and the predicted outputs ‘fₑ(x)’. The server system 200 may calculate the consistency loss ‘lᵤ’ 336 between the original samples ‘x’ 304 (i.e., the set of labeled numerical embeddings and the set of unlabeled numerical embeddings) and their corrupted and masked (i.e., distorted) versions ‘\tilde{x}’ 306 (i.e., the set of distorted labeled numerical embeddings and the set of distorted unlabeled numerical embeddings), and is based on the principle of consistency regularization. In other words, the server system 200 is configured to fine-tune (rather re-tune) the first transformer model 124 based, at least in part, on the semi-supervised loss. During training, K augmented samples such as \tilde{x}₁, . . . , \tilde{x}ₖ are created for each sample ‘x’ϵ‘Dᵤ’ in the batch. Further, the server system 200 may regularize ‘f’ to make similar predictions 338 (output 338) on the original and augmented (distorted) samples.

FIG. 3C illustrates a schematic representation of an overall architecture 360 of a hierarchical transformer-based model, in accordance with an embodiment of the present disclosure. As illustrated in FIG. 3C, the hierarchical transformer-based model includes a first transformer model 370, a second transformer model 372, and a third transformer model 374. In an embodiment, the first transformer model 370, the second transformer model 372, and the third transformer model 374 are similar to the first transformer model 124, the second transformer model 126, and the third transformer model 128 of FIG. 1.

In the non-limiting implementation depicted in FIG. 3C, the first transformer model 370, the second transformer model 372, and the third transformer model 374 are all shown to have similar components, i.e., an add and norm layer, a feed-forward layer, and a multi-headed attention layer. The add and norm layer is responsible for addressing the problem of vanishing gradients and facilitating a better flow of information across layers. It includes the steps of addition and layer normalization. During the addition step, the output from the previous layer or sub-layer is added element-wise to the input or residual connection. During the layer normalization step, layer normalization is applied to the summed values for stabilizing the learning process. The feed-forward layer provides a non-linear transformation on the input embeddings or representations, thus allowing the transformer model to capture complex patterns and relationships in the data. The multi-headed attention layer is responsible for capturing different types of relationships and dependencies within the input data. It is noted that these components of the N layer transformer-based models are well known in the art, therefore they are not explained in further detail herein, for the sake of brevity.

In an embodiment, the server system 200 proposed in the present disclosure may focus on four key aspects of self-supervised learning and semi-supervised learning, namely feature encoding, self-supervised pretraining, semi-supervised training, and generation of the overall architecture 360 (hereinafter, also referred to as ‘neural architecture 360’), and make contributions in all these directions. Feature encoding is done by splitting the features into categorical features 362 and numerical features 364 and then encoding them.

As described earlier, feature encoding may use the transformer architecture 360 (or the neural/overall architecture) to learn contextual representations (embeddings) for each of the categorical features 362 and the numerical features 364. Prior to this step, the server system 200 may generate categorical embeddings 366 (hereinafter, also referred to as ‘column embeddings 366’ and/or ‘column embedding 366’) and numerical embeddings 368 (hereinafter, also referred to as ‘numerical embedding 368’) corresponding to the categorical features 362 and the numerical features 364, respectively. Further, the server system 200 may pass the categorical embeddings 366 and the numerical embeddings 368 through the neural architecture 360 of the first transformer model 370 including an encoder, and the second transformer model 372 including another encoder, respectively as shown in FIG. 3C. The first transformer model 370 and the second transformer model 372 may include a transformer having components as explained in the description of FIG. 1 of the present disclosure. In a non-limiting example, the transformer may be an N-layer transformer, wherein N may be a non-zero natural number.

For the pretraining objective, the server system 200 may use the principle of redundancy reduction by measuring the cross-correlation matrix between the representations of the original and distorted samples and making it as close to the identity matrix as possible. The semi-supervised training employs a distortion strategy to augment the tabular dataset 216. This is further used to minimize supervised loss and regularization consistency losses. Finally, the third transformer model 374 learns from the effective mixing of the contextual representations learned in the step of feature encoding that is used for the neural architecture 360. It is noted that the contextual representations are obtained by concatenating the categorical embeddings 366 and the numerical embeddings 368 by passing through a concatenation layer 376, prior to transmitting them to the third transformer model 374 for effective mixing. Further, the output of the transformer 374 may be given to a prediction head 378, where predictive analysis or the prediction task may be performed based on the concatenated and mixed contextual embeddings. In various non-limiting examples, the prediction tasks or applications may be determined by the administrator associated with the server system 200.

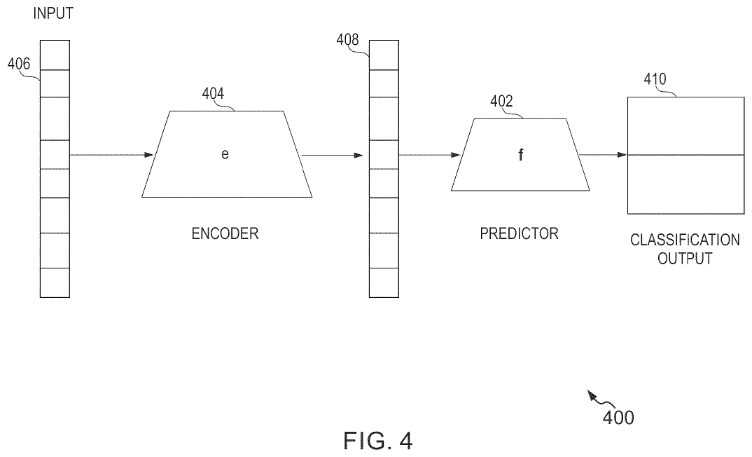

FIG. 4 illustrates a schematic representation of an architecture 400 used during a testing phase of the hierarchical transformer-based model and a prediction head such as a predictor ‘f’ 402 for performing the prediction task, in accordance with an embodiment of the present disclosure. In an embodiment, the hierarchical transformer-based model may include an encoder ‘e’ 404 which is trained and fine-tuned by the server system 200 by applying the various operations described with reference to FIG. 3C.

In some embodiments, after training, the prediction for a new test sample ‘xₜ’ is given by ‘ŷ=fₑ(xₜ)’. For testing on a data sample such as ‘x’ 406 or ‘xₜ’, the server system 200 may use the hierarchical encoder such as 404, to learn the encoded representation (embeddings) 408. Further, the encoded embeddings 408 may be fed into the predictor 402 learned in the semi-supervised learning stage for obtaining a classification output 410.

Various experiments have been performed to evaluate the performance of the various embodiments described by the present disclosure. One such experiment included evaluating the performance of the hierarchical transformer-based model by implementing the model on a range of benchmark tabular datasets, including medium-sized datasets such as MNIST, Adult, and BlogFeedback, and larger ones like Covertype. The experiments may be set up in a similar manner to VIME for a fair comparison. The results of the experiments are shown in Table 1. It is noted that the results shown in Table 1 are approximate in nature. In other words, the results shown in Table 1 may have an error of ±3% to 5%.

TABLE 1
Dataset statistics

| Datasets | Features | Numerical | Categorical | Instances | Classes |
|---|---|---|---|---|---|
| MINST | 784 | 784 | 0 | 70,000 | 10 |
| Adult | 14 | 6 | 8 | 48,842 | 2 |
| Blog- | 281 | 266 | 15 | 60,021 | 2 |
| Feedback | | | | | |
| Covertype | 54 | 10 | 44 | 581,012 | 7 |

With reference to Table 1, it is understood that various dataset statistics related to the corresponding example tabular datasets are considered for the testing phase. As may be understood, the MNIST dataset consists of 28×28 grayscale images, where the task is 10-class classification as to which digit is present in the image. This dataset has predefined train and test sets. The train set consists of 60,000 examples and the test set consists of 10,000 examples. Further, it may be interpreted from Table 1, that the 28×28 pixels in an image are 784 numerical features.

Further, the adult dataset is a multivariate tabular dataset that consists of 48,842 instances overall. The dataset has 14 attributes where 6 are numeric and 8 are categorical. The predictive task is to predict whether a given person described by features earns more than $50,000 per annum or not. It is noted that this task is a binary classification task.

Furthermore, the data BlogFeedback dataset originates from blog posts. The raw HTML documents of the blog posts may be crawled and processed. The prediction task associated with the data is to predict the number of comments in the 24 hours after the blog post was published. The dataset consists of 60,021 instances with 281 attributes. Out of these 266 attributes are numeric and the rest 15 attributes are categorical. Though this is a regression dataset, the target is to predict whether the blog will get a comment or not (number of comments >0), which is a binary classification task.

Furthermore, the Covertype dataset is another tabular dataset. This dataset consists of the problem of classifying the cover type given cartographic variables. It consists of 581,012 instances with 54 attributes. Out of these 14 attributes are numerical and the rest 40 are categorical. This translates to multi-class classification with 7 classes to be predicted.

Further, in a non-limiting example, the experiment protocol may include using the above-mentioned four open-source tabular datasets in the experiments. These datasets do not have defined train and test sets with the exception of MNIST, which has a train set of 60,000 and a test set of 10,000. The dataset statistics are presented in Table I. For the rest of the datasets, the experiments followed an 80%, 20% split where 80% is the training set and 20% is the test set. For the experiments only 10% of the labeled data may be used and the rest, 90% may be treated as additional unlabeled data and used for self-supervised redundancy reducing pre-training and consistency-based semi-supervised training steps. Further, the neural architecture 360 proposed in the present disclosure may be compared against baselines such as Multi-layer Perceptron (MLP) and extreme gradient boosting (XGBoost) which are purely supervised, and SCARF which either have a self-supervised or semi-supervised component associated with them.

TABLE 2
Performance Accuracy comparison for the
proposed method and different methods

| | Datasets | | | |
|---|---|---|---|---|
| Method | MNIST | Adult | Blog | Cover |
| TabNet | 91.63 | 82.54 | 80.32 | 77.48 |
| MLP | 94.80 | 82.61 | 79.51 | 76.06 |
| XGBoost | 89.13 | 82.38 | 80.24 | 76.55 |
| VIME | 95.23 | 84.35 | 81.44 | 80.28 |
| Tab Transformer | 94.80 | 83.23 | 80.72 | 80.97 |
| SCARF | 96.14 | 84.29 | 81.60 | 80.97 |
| Proposed method | 97.08 | 86.62 | 82.96 | 82.35 |

Table 2 describes a performance comparison of the proposed approach with conventional methods. The aforementioned method achieves state-of-the-art (SOTA) results on common public tabular datasets in the less labeled data domain convincingly beating strong baselines like MLP, XgBoost, and VIME showcasing the efficacy of our approach. It is noted that the results shown in Table 2 are approximate in nature. In other words, the results shown in Table 2 may have an error of ±3% to 5%.

Further, Table 2 shows the performance comparison of the proposed method with the existing baseline methods on 10% of the data. It may be observed that 34 or all 4 datasets, the performance accuracy of the proposed method outperforms the conventional methods.

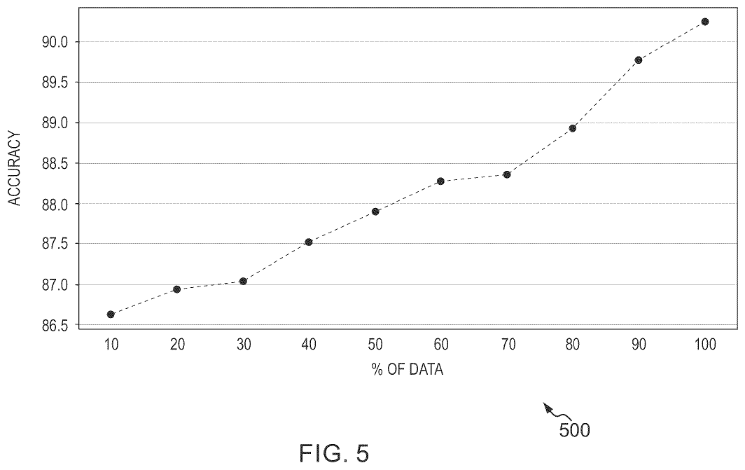

FIG. 5 illustrates a graphical representation 500 of an effect of an amount of data on the performance of the neural architecture 360, in accordance with an embodiment of the present disclosure.

The adult dataset may be considered for an ablation study and ablated against each component of the proposed method such as featuring encoding, self-supervised task, semi-supervised pretraining, and a hierarchical transformer architecture. Based on the ablation study performed, the accuracy of the system with respect to each component of the system, which determines the importance of each component is shown in the following table:

TABLE 3
Ablation study results

| Method | Accuracy |
|---|---|
| With supervision | 82.65 |
| Without pre-training | 84.12 |
| Without semi-supervised training | 85.93 |
| Without feature encoding | 84.65 |
| Without transformers | 84.29 |

As per an experiment, the ablation study was conducted on the Adult dataset described to evaluate the performance gain of each component. The experiment conducted may analyze the effect of five variations of the proposed method as shown in Table 3, such as:
With supervision
Without pre-training
Without semi-supervised training
Without feature encoding
Without transformers

Table 3 illustrates the performance change corresponding to every component. It is noted that the results shown in Table 3 are approximate in nature. In other words, the results shown in Table 3 may have an error of ±3% to 5%. Using the ablations, it can be understood that the self-supervised pretraining and transformer architecture are the most important components in the algorithm, the accuracy may suffer almost a 4 percent (%) drop when either of these are removed.

TABLE 4
Performance accuracy comparison on adult data

| Method | Accuracy |
|---|---|
| MLP | 86.25 |
| XGBoost | 88.64 |
| VIME | 88.23 |
| Proposed method | 90.24 |

Through extensive experimentation on four public tabular datasets such as MNIST, Adult, BlogFeedback, and Covertype, it may be concluded that the prosed method gives state-of-the-art results against strong/state-of-the-art baselines like TabTransformer, TabNet, VIME, and SCARF. The proposed method connivingly outperforms these algorithms by an average of 3% on all the datasets. The proposed method is also compared on 100% labeled data given in Table 4 using the adult dataset and finds that it achieves state-of-the-art results convincingly beating baselines like MLP, XGBoost, and VIME. The proposed method may also be trained on different amounts of data on the adult dataset and find an almost linear increase as illustrated in FIG. 5. It is noted that the results shown in Table 4 are approximate in nature. In other words, the results shown in Table 4 may have an error of ±3% to 5%.

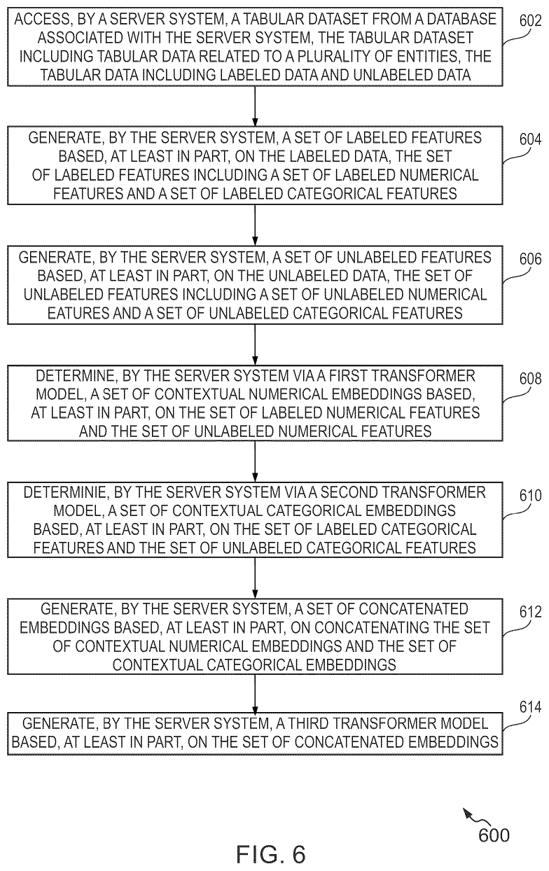

FIG. 6 illustrates a process flow diagram depicting a method 600 for training an artificial intelligence (AI)-based model using limited labeled data, in accordance with an embodiment of the present disclosure. The sequence of operations of the method 600 may not be necessarily executed in the same order as they are presented. Further, one or more operations may be grouped and performed in the form of a single step, or one operation may have several sub-steps that may be performed in parallel or in a sequential manner. Operations of the method 600, and combinations of operations in the method 600 may be implemented by, for example, hardware, firmware, a processor, circuitry, and/or a different device associated with the execution of software that includes one or more computer program instructions. The plurality of operations is depicted in the process flow of the method 600. The process flow starts at operation 602.

At 602, the method 600 includes accessing, by a server system (e.g., the server system 200), a tabular dataset (e.g., the tabular dataset 216) from a database (e.g., the database 204) associated with the server system 200. In an embodiment, the tabular dataset 216 may include tabular data related to a plurality of entities. Further, the tabular data may include labeled data and unlabeled data.

At 604, the method 600 includes generating, by the server system 200, a set of labeled features based, at least in part, on the labeled data. In an embodiment, the set of labeled features may include a set of labeled numerical features and a set of labeled categorical features.

At 606, the method 600 includes generating, by the server system 200, a set of unlabeled features based, at least in part, on the unlabeled data. In an embodiment, the set of unlabeled features may include a set of unlabeled numerical features and a set of unlabeled categorical features.

At 608, the method 600 includes determining, by the server system 200 via a first transformer model (e.g., the first transformer model 218), a set of contextual numerical embeddings based, at least in part, on the set of labeled numerical features and the set of unlabeled numerical features.

At 610, the method 600 includes determining, by the server system 200 via a second transformer model (e.g., the second transformer model 220), a set of contextual categorical embeddings based, at least in part, on the set of labeled categorical features and the set of unlabeled categorical features.

At step 612, the method 600 includes generating, by the server system 200, a set of concatenated embeddings based, at least in part, on concatenating the set of contextual numerical embeddings and the set of contextual categorical embeddings.

At step 614, the method 600 includes generating, by the server system 200, a third transformer model (e.g., the third transformer model 222) based, at least in part, on the set of concatenated embeddings.

FIG. 7A illustrates a process flow diagram depicting a method 700 for training a first transformer model such as the first transformer model 218 during the self-supervised learning stage, in accordance with an embodiment of the present disclosure. The sequence of operations of the method 700 may not be necessarily executed in the same order as they are presented. Further, one or more operations may be grouped and performed in the form of a single step, or one operation may have several sub-steps that may be performed in parallel or in a sequential manner. Operations of the method 700, and combinations of operations in the method 700 may be implemented by, for example, hardware, firmware, a processor, circuitry, and/or a different device associated with the execution of software that includes one or more computer program instructions. The plurality of operations is depicted in the process flow of the method 700. The process flow starts at operation 702.

At step 702, the method 700 includes initializing a first transformer model such as the first transformer model 218 based, at least in part, on a set of first transformer weights. As may be understood, for a first iteration the first transformer model 218 is initialized using initial weights that may be defined by an administrator (not shown) of the server system 200.

At step 704, the method 700 includes generating a set of distorted unlabeled numerical features based, at least in part, on a set of unlabeled numerical features. The process for generating the unlabeled numerical features has been described earlier therefore, an explanation for the same is not provided again.

At step 706, the method 700 includes generating a set of unlabeled numerical embeddings based, at least in part, on the set of unlabeled numerical features.

At step 708, the method 700 includes generating a set of distorted unlabeled numerical embeddings based, at least in part, on the set of distorted unlabeled numerical features.

At step 710, the method 700 includes generating, via the first transformer model 218, a first set of contextual numerical embeddings based, at least in part, on the set of unlabeled numerical embeddings.

At step 712, the method 700 includes generating, via the first transformer model 218, a second set of contextual numerical embeddings based, at least in part, on the set of distorted unlabeled numerical embeddings.

At step 714, the method 700 includes computing a self-supervised loss by comparing the first set of contextual numerical embeddings and the second set of contextual numerical embeddings.

At step 716, the method 700 includes fine-tuning the first transformer model 218 based, at least in part, on the self-supervised loss. Herein, the fine-tuning may include adjusting the set of first transformer weights.

At step 718, the method 700 includes iteratively performing the first set of self-supervised learning operations till a first criterion is satisfied. Herein, the first criterion is defined at a stage in the iterative process where due to the adjustments (i.e., fine-tuning) in the weights of the first transformer model 218 (called, the set of first transformer weights) the self-supervised loss is minimized or reduced till it becomes nearly nil (or zero) or saturates. In other words, at step 718, the server system 200 checks if the first criterion is satisfied. If the first criterion is not met, the server system 200 performs steps 702 to 716, again in the subsequent iteration. It is noted that for the subsequent iteration, the first transformer model 218 is generated based on the fine-tuned or adjusted set of first transformer model weights. Due to this aspect, the self-supervised loss would be different from the previous iteration. When the first criterion is met, the server system 200 stops the training process.

FIG. 7B illustrates a process flow diagram depicting a method 720 for training a second transformer model such as the second transformer model 220 during the self-supervised learning stage, in accordance with an embodiment of the present disclosure. The sequence of operations of the method 720 may not be necessarily executed in the same order as they are presented. Further, one or more operations may be grouped and performed in the form of a single step, or one operation may have several sub-steps that may be performed in parallel or in a sequential manner. Operations of the method 720, and combinations of operations in the method 720 may be implemented by, for example, hardware, firmware, a processor, circuitry, and/or a different device associated with the execution of software that includes one or more computer program instructions. The plurality of operations is depicted in the process flow of the method 720. The process flow starts at operation 722.

At step 722, the method 720 includes initializing a second transformer model such as the second transformer model 220 based, at least in part, on a set of second transformer weights. As may be understood, for a first iteration the second transformer model 220 is initialized using initial weights that may be defined by an administrator (not shown) of the server system 200.

At step 724, the method 720 includes generating a set of distorted unlabeled categorical features based, at least in part, on a set of unlabeled categorical features. The process for generating the unlabeled categorical features has been described earlier therefore, an explanation for the same is not provided again.

At step 726, the method 720 includes generating a set of unlabeled categorical embeddings based, at least in part, on the set of unlabeled categorical features.

At step 728, the method 720 includes generating a set of distorted unlabeled categorical embeddings based, at least in part, on the set of distorted unlabeled categorical features.

At step 730, the method 720 includes generating, via the second transformer model 220, a first set of contextual categorical embeddings based, at least in part, on the set of unlabeled categorical embeddings.

At step 732, the method 720 includes generating, via the second transformer model 220, a second set of contextual categorical embeddings based, at least in part, on the set of distorted unlabeled categorical embeddings.

At step 734, the method 720 includes computing a self-supervised loss by comparing the second set of contextual categorical embeddings and the second set of contextual categorical embeddings.

At step 736, the method 720 includes fine-tuning the second transformer model 220 based, at least in part, on the self-supervised loss. Herein, the fine-tuning may include adjusting the set of second transformer weights.

At step 738, the method 720 includes iteratively performs the second set of self-supervised learning operations till a third criterion is satisfied. Herein, the third criterion is defined at a stage in the iterative process where due to the adjustments (i.e., fine-tuning) in the weights of the second transformer model 220 (called, the set of second transformer weights) the self-supervised loss is minimized or reduced till it becomes nearly nil (or zero) or saturates. In other words, at step 738, the server system 200 checks if the third criterion is satisfied. If the third criterion is not met, the server system 200 performs steps 722 to 736, again in the subsequent iteration. It is noted that for the subsequent iteration, the second transformer model 220 is generated based on the fine-tuned or adjusted set of second transformer model weights. Due to this aspect, the self-supervised loss would be different from the previous iteration. When the third criterion is met, the server system 200 stops the training process.

FIG. 8A illustrates a process flow diagram depicting a method 800 for training the first transformer model such as the first transformer model 218 during the semi-supervised learning stage, in accordance with an embodiment of the present disclosure. The sequence of operations of the method 800 may not be necessarily executed in the same order as they are presented. Further, one or more operations may be grouped and performed in the form of a single step, or one operation may have several sub-steps that may be performed in parallel or in a sequential manner. Operations of the method 800, and combinations of operations in the method 800 may be implemented by, for example, hardware, firmware, a processor, circuitry, and/or a different device associated with the execution of software that includes one or more computer program instructions. The plurality of operations is depicted in the process flow of the method 800. The process flow starts at operation 802.

At 802, the method 800 includes initializing the first transformer model 218 based, at least in part, on a set of first transformer weights. It is to be noted that since the semi-supervised learning stage is performed after the self-supervised learning stage, the first transformer weights in this stage are equivalent to the first transformer weights in the final iteration of the self-supervised learning stage described by FIG. 7A. To that end, the goal of the semi-supervised learning stage is to take the understanding or learning from the self-supervised learning stage and adjust the weights further to improve the learning of the first transformer model 218.

At 804, the method 800 includes generating a set of labeled numerical embeddings based, at least in part, on the set of labeled numerical features.

At 806, the method 800 includes generating a set of distorted labeled numerical embeddings based, at least in part, on the set of labeled numerical embeddings.

At 808, the method 800 includes generating a set of distorted unlabeled numerical features based, at least in part, on the set of unlabeled numerical features.

At 810, the method 800 includes generating a set of distorted unlabeled numerical embeddings based, at least in part, on the set of distorted unlabeled numerical features.

At 812, the method 800 includes generating, via the first transformer model, a fourth set of contextual numerical embeddings based, at least in part, on the set of distorted labeled numerical embeddings and the set of distorted unlabeled numerical embeddings.

At 814, the method 800 includes computing a semi-supervised loss by comparing the third set of contextual numerical embeddings and the fourth set of contextual numerical embeddings.

At 816, the method 800 includes fine-tuning the first transformer model based, at least in part, on the semi-supervised loss. Herein, the fine-tuning may include adjusting the set of first transformer weights.

At 818, the method includes iteratively performing the first set of semi-supervised learning operations till a second criterion is satisfied. Herein, the second criterion is defined at a stage in the iterative process where due to the adjustments (i.e., fine-tuning) in the weights of the first transformer model 218 (called, the set of first transformer weights) the semi-supervised loss is minimized or reduced till it becomes nearly nil (or zero) or saturates. In other words, at step 818, the server system 200 checks if the second criterion is satisfied. If the second criterion is not met, the server system 200 performs steps 802 to 816, again in the subsequent iteration. It is noted that for the subsequent iteration, the first transformer model 218 is generated based on the fine-tuned or adjusted set of first transformer model weights. Due to this aspect, the semi-supervised loss would be different from the previous iteration. When the second criterion is met, the server system 200 stops the training process.

FIG. 8B illustrates a process flow diagram depicting a method 820 for training the second transformer model such as the second transformer model 220 during the semi-supervised learning stage, in accordance with an embodiment of the present disclosure. The sequence of operations of the method 820 may not be necessarily executed in the same order as they are presented. Further, one or more operations may be grouped and performed in the form of a single step, or one operation may have several sub-steps that may be performed in parallel or in a sequential manner. Operations of the method 820, and combinations of operations in the method 820 may be implemented by, for example, hardware, firmware, a processor, circuitry, and/or a different device associated with the execution of software that includes one or more computer program instructions. The plurality of operations is depicted in the process flow of the method 820. The process flow starts at operation 822.

At 822, the method 820 includes initializing the second transformer model 220 based, at least in part, on a set of second transformer weights. It noted that since the semi-supervised learning stage is performed after the self-supervised learning stage, therefore the second transformer weights in this stage are equivalent to the second transformer weights in the final iteration of the self-supervised learning stage described by FIG. 7B. To that end, the goal of the semi-supervised learning stage is to take the understanding or learning from the self-supervised learning stage and adjust the weights further to improve the learning of the second transformer model 220.

At 824, the method 820 includes generating a set of labeled categorical embeddings based, at least in part, on the set of labeled categorical features.

At 826, the method 820 includes generating a set of distorted labeled categorical embeddings based, at least in part, on the set of labeled categorical embeddings.

At 828, the method 820 includes generating a set of distorted unlabeled categorical features based, at least in part, on the set of unlabeled categorical features.

At 830, the method 820 includes generating a set of distorted unlabeled categorical embeddings based, at least in part, on the set of distorted unlabeled categorical features.

At 832, the method 820 includes generating, via the second transformer model 220, a fourth set of contextual categorical embeddings based, at least in part, on the set of distorted labeled categorical embeddings and the set of distorted unlabeled categorical embeddings.

At 834, the method 200 includes computing a semi-supervised loss by comparing the third set of contextual categorical embeddings and the fourth set of contextual categorical embeddings.

At 836, the method 820 includes fine-tuning the second transformer model 220 based, at least in part, on the semi-supervised loss. Herein, the fine-tuning may include adjusting the set of second transformer weights.

At 838, the method 820 includes iteratively performing the first set of semi-supervised learning operations till a fourth criterion is satisfied. Herein, the fourth criterion is defined at a stage in the iterative process where due to the adjustments (i.e., fine-tuning) in the weights of the second transformer model 220 (called, the set of second transformer weights) the semi-supervised loss is minimized or reduced till it becomes nearly nil (or zero) or saturates. In other words, at step 838, the server system 200 checks if the fourth criterion is satisfied. If the fourth criterion is not met, the server system 200 performs steps 822 to 836, again in the subsequent iteration. It is noted that for the subsequent iteration, the second transformer model 220 is generated based on the fine-tuned or adjusted set of second transformer model weights. Due to this aspect, the semi-supervised loss would be different from the previous iteration. When the fourth criterion is met, the server system 200 stops the training process.

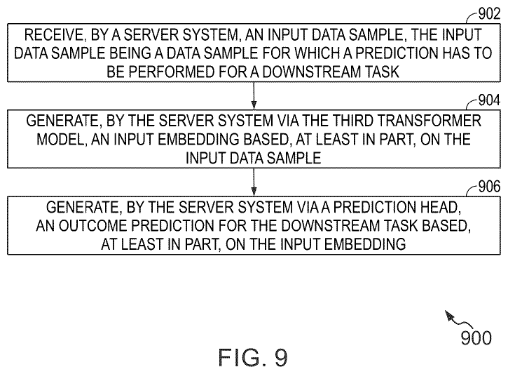

FIG. 9 illustrates a process flow diagram depicting a method 900 for performing a prediction for a downstream task, in accordance with an embodiment of the present disclosure. The sequence of operations of the method 900 may not be necessarily executed in the same order as they are presented. Further, one or more operations may be grouped and performed in the form of a single step, or one operation may have several sub-steps that may be performed in parallel or in a sequential manner. Operations of the method 900, and combinations of operations in the method 900 may be implemented by, for example, hardware, firmware, a processor, circuitry, and/or a different device associated with the execution of software that includes one or more computer program instructions. The plurality of operations is depicted in the process flow of the method 920. The process flow starts at operation 902.

At 902, the method 900 includes receiving, by a server system (e.g., the server system 200), an input data sample, the input data sample being a data sample for which a prediction has to be performed for a downstream task. In an exemplary scenario, the tabular data used for training the first, second, and third transformer models (218-222) is a payment transaction dataset and the downstream task is fraud prediction. Then, for a new payment transaction (i.e., input data sample), the third transformer model 222 performs fraud detection.

At 902, the method 900 includes generating, by the server system 200 via the third transformer model 222, an input embedding based, at least in part, on the input data sample.

At 902, the method 900 includes generating, by the server system 200 via a prediction head, an outcome prediction for the downstream task based, at least in part, on the input embedding. Here, the prediction head is selected based on the downstream task for which the embeddings are generated. Returning to the previous scenario, the prediction head associated with the third transformer model 222 may predict whether the new payment transaction is fraudulent or non-fraudulent. In some instances, the prediction head may be selected by an administrator (not shown) of the server system 200.

As may be appreciated, the prediction head performs the prediction using the output of the third transformer model 222 which combines the learning of the first transformer model 218 and the second transformer model 220. This aspect improves the performance of the third transformer model 222 which in turn improves the accuracy of the prediction (i.e., outcome prediction)

The disclosed method with reference to FIG. 6 to FIG. 9, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad scope of the invention. For example, the various operations, blocks, etc., described herein may be enabled and operated using hardware circuitry (for example, complementary metal oxide semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or the computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media. Examples of non-transitory computer-readable media include magnetic storage media (such as floppy disks, magnetic tapes, hard disk drives, etc.), optical magnetic storage media (e.g. magneto-optical disks), Compact Disc Read-Only Memory (CD-ROM), Compact Disc Recordable CD-R, Compact Disc Rewritable CD-R/W), Digital Versatile Disc (DVD), BLU-RAY® Disc (BD), and semiconductor memories (such as mask ROM, programmable ROM (PROM), Erasable PROM (EPROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different from those which, are disclosed. Therefore, although the invention has been described based on these exemplary embodiments, it is noted that certain modifications, variations, and alternative constructions may be apparent and well within the scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method comprising:
accessing, by a server system, a tabular dataset from a database associated with the server system, the tabular dataset comprising tabular data related to a plurality of entities, the tabular data comprising labeled data and unlabeled data;
generating, by the server system, a set of labeled features based, at least in part, on the labeled data, the set of labeled features comprising a set of labeled numerical features and a set of labeled categorical features;
generating, by the server system, a set of unlabeled features based, at least in part, on the unlabeled data, the set of unlabeled features comprising a set of unlabeled numerical features and a set of unlabeled categorical features;
determining, by the server system via a first transformer model, a set of contextual numerical embeddings based, at least in part, on the set of labeled numerical features and the set of unlabeled numerical features;
determining, by the server system via a second transformer model, a set of contextual categorical embeddings based, at least in part, on the set of labeled categorical features and the set of unlabeled categorical features;
generating, by the server system, a set of concatenated embeddings based, at least in part, on concatenating the set of contextual numerical embeddings and the set of contextual categorical embeddings; and
generating, by the server system, a third transformer model based, at least in part, on the set of concatenated embeddings.

2. The computer-implemented method as claimed in claim 1, further comprising:
generating, by the server system, the first transformer model based, at least in part, on iteratively performing a first set of self-supervised learning operations till a first criterion and a first set of semi-supervised learning operations till a second criterion are met.

3. The computer-implemented method as claimed in claim 2, wherein the first set of self-supervised learning operations comprises:
initializing the first transformer model based, at least in part, on a set of first transformer weights;
generating a set of distorted unlabeled numerical features based, at least in part, on the set of unlabeled numerical features;
generating a set of unlabeled numerical embeddings based, at least in part, on the set of unlabeled numerical features;
generating a set of distorted unlabeled numerical embeddings based, at least in part, on the set of distorted unlabeled numerical features;
generating, via the first transformer model, a first set of contextual numerical embeddings based, at least in part, on the set of unlabeled numerical embeddings;
generating, via the first transformer model, a second set of contextual numerical embeddings based, at least in part, on the set of distorted unlabeled numerical embeddings;
computing a self-supervised loss by comparing the first set of contextual numerical embeddings and the second set of contextual numerical embeddings; and
fine-tuning the first transformer model based, at least in part, on the self-supervised loss, wherein the fine-tuning comprises adjusting the set of first transformer weights.

4. The computer-implemented method as claimed in claim 2, wherein the first set of semi-supervised learning operations comprises:
initializing the first transformer model based, at least in part, on a set of first transformer weights;
generating a set of labeled numerical embeddings based, at least in part, on the set of labeled numerical features;
generating a set of distorted labeled numerical embeddings based, at least in part, on the set of labeled numerical embeddings;
generating a set of distorted unlabeled numerical features based, at least in part, on the set of unlabeled numerical features;
generating a set of distorted unlabeled numerical embeddings based, at least in part, on the set of distorted unlabeled numerical features;
generating, via the first transformer model, a third set of contextual numerical embeddings based, at least in part, on the set of labeled numerical embeddings and the set of unlabeled numerical embeddings;
generating, via the first transformer model, a fourth set of contextual numerical embeddings based, at least in part, on the set of distorted labeled numerical embeddings and the set of distorted unlabeled numerical embeddings;
computing a semi-supervised loss by comparing the third set of contextual numerical embeddings and the fourth set of contextual numerical embeddings; and
fine-tuning the first transformer model based, at least in part, on the semi-supervised loss, wherein the fine-tuning comprises adjusting the set of first transformer weights.

5. The computer-implemented method as claimed in claim 1, further comprising:
generating, by the server system, the second transformer model based, at least in part, on iteratively performing a second set of self-supervised learning operations till a third criterion and a second set of semi-supervised learning operations till a fourth criterion.

6. The computer-implemented method as claimed in claim 5, wherein the second set of self-supervised learning operations comprises:
initializing the second transformer model based, at least in part, on a set of second transformer weights;
generating a set of distorted unlabeled categorical features based, at least in part, on the set of unlabeled categorical features;
generating a set of unlabeled categorical embeddings based, at least in part, on the set of unlabeled categorical features;
generating a set of distorted unlabeled categorical embeddings based, at least in part, on the set of distorted unlabeled categorical features;
generating, via the second transformer model, a first set of contextual categorical embeddings based, at least in part, on the set of unlabeled categorical embeddings;
generating, via the second transformer model, a second set of contextual categorical embeddings based, at least in part, on the set of distorted unlabeled categorical embeddings;
computing a self-supervised loss by comparing the first set of contextual categorical embeddings and the second set of contextual categorical embeddings; and
fine-tuning the second transformer model based, at least in part, on the self-supervised loss, wherein the fine-tuning comprises adjusting the set of second transformer weights.

7. The computer-implemented method as claimed in claim 5, wherein the second set of semi-supervised learning operations comprises:
initializing the second transformer model based, at least in part, on a set of second transformer weights;
generating a set of labeled categorical embeddings based, at least in part, on the set of labeled categorical features;
generating a set of distorted labeled categorical embeddings based, at least in part, on the set of labeled categorical embeddings;
generating a set of distorted unlabeled categorical features based, at least in part, on the set of unlabeled categorical features;
generating a set of distorted unlabeled categorical embeddings based, at least in part, on the set of distorted unlabeled categorical features;
generating, via the second transformer model, a third set of contextual categorical embeddings based, at least in part, on the set of labeled categorical embeddings and the set of unlabeled categorical embeddings;
generating, via the second transformer model, a fourth set of contextual categorical embeddings based, at least in part, on the set of distorted labeled categorical embeddings and the set of distorted unlabeled categorical embeddings;
computing a semi-supervised loss by comparing the third set of contextual categorical embeddings and the fourth set of contextual categorical embeddings; and
fine-tuning the second transformer model based, at least in part, on the semi-supervised loss, wherein the fine-tuning comprises adjusting the set of second transformer weights.

8. The computer-implemented method as claimed in claim 1, further comprising:
receiving, by a server system, an input data sample, the input data sample being a data sample for which a prediction has to be performed for a downstream task;
generating, by the server system via the third transformer model, an input embedding based, at least in part, on the input data sample; and
generating, by the server system via a prediction head, an outcome prediction for the downstream task based, at least in part, on the input embedding.

9. The computer-implemented method as claimed in claim 8, wherein the prediction head is selected based, at least in part, on the downstream task.

10. A server system, comprising:
a communication interface;
a memory comprising machine-readable instructions; and
a processor communicably coupled to the communication interface and the memory, the processor configured to execute the machine-readable instructions to cause the server system at least in part to:
access a tabular dataset from a database associated with the server system, the tabular dataset comprising tabular data related to a plurality of entities, the tabular data comprising labeled data and unlabeled data;
generate a set of labeled features based, at least in part, on the labeled data, the set of labeled features comprising a set of labeled numerical features and a set of labeled categorical features;
generate a set of unlabeled features based, at least in part, on the unlabeled data, the set of unlabeled features comprising a set of unlabeled numerical features and a set of unlabeled categorical features;
determine, by the server system via a first transformer model, a set of contextual numerical embeddings based, at least in part, on the set of labeled numerical features and the set of unlabeled numerical features;
determine, by the server system via a second transformer model, a set of contextual categorical embeddings based, at least in part, on the set of labeled categorical features and the set of unlabeled categorical features;
generate a set of concatenated embeddings based, at least in part, on concatenating the set of contextual numerical embeddings and the set of contextual categorical embeddings; and
generate a third transformer model based, at least in part, on the set of concatenated embeddings.

11. The server system as claimed in claim 10, wherein the server system is caused, at least in part, to:
generate the first transformer model based, at least in part, on iteratively performing a first set of self-supervised learning operations till a first criterion and a first set of semi-supervised learning operations till a second criterion.

12. The server system as claimed in claim 11, wherein the first set of self-supervised learning operations comprises:
initialize the first transformer model based, at least in part, on a set of first transformer weights;
generate a set of distorted unlabeled numerical features based, at least in part, on the set of unlabeled numerical features;
generate a set of unlabeled numerical embeddings based, at least in part, on the set of unlabeled numerical features;
generate a set of distorted unlabeled numerical embeddings based, at least in part, on the set of distorted unlabeled numerical features;
generate, via the first transformer model, a first set of contextual numerical embeddings based, at least in part, on the set of unlabeled numerical embeddings;
generate, via the first transformer model, a second set of contextual numerical embeddings based, at least in part, on the set of distorted unlabeled numerical embeddings;
compute a self-supervised loss by comparing the first set of contextual numerical embeddings and the second set of contextual numerical embeddings; and
fine-tune the first transformer model based, at least in part, on the self-supervised loss, wherein the fine-tuning comprises adjusting the set of first transformer weights.

13. The server system as claimed in claim 11, wherein the first set of semi-supervised learning operations comprises:
initialize the first transformer model based, at least in part, on a set of first transformer weights;
generate a set of labeled numerical embeddings based, at least in part, on the set of labeled numerical features;
generate a set of distorted labeled numerical embeddings based, at least in part, on the set of labeled numerical embeddings;
generate a set of distorted unlabeled numerical features based, at least in part, on the set of unlabeled numerical features;
generate a set of distorted unlabeled numerical embeddings based, at least in part, on the set of distorted unlabeled numerical features;
generate, via the first transformer model, a third set of contextual numerical embeddings based, at least in part, on the set of labeled numerical embeddings and the set of unlabeled numerical embeddings;
generate, via the first transformer model, a fourth set of contextual numerical embeddings based, at least in part, on the set of distorted labeled numerical embeddings and the set of distorted unlabeled numerical embeddings;
compute a semi-supervised loss by comparing the third set of contextual numerical embeddings and the fourth set of contextual numerical embeddings; and
fine-tune the first transformer model based, at least in part, on the semi-supervised loss, wherein the fine-tuning comprises adjusting the set of first transformer weights.

14. The server system as claimed in claim 10, wherein the server system is caused, at least in part, to:
generate the second transformer model based, at least in part, on iteratively performing a second set of self-supervised learning operations till a third criterion and a second set of semi-supervised learning operations till a fourth criterion.

15. The server system as claimed in claim 14, wherein the second set of self-supervised learning operations comprises:
initialize the second transformer model based, at least in part, on a set of second transformer weights;
generate a set of distorted unlabeled categorical features based, at least in part, on the set of unlabeled categorical features;
generate a set of unlabeled categorical embeddings based, at least in part, on the set of unlabeled categorical features;
generate a set of distorted unlabeled categorical embeddings based, at least in part, on the set of distorted unlabeled categorical features;
generate, via the second transformer model, a first set of contextual categorical embeddings based, at least in part, on the set of unlabeled categorical embeddings;
generate, via the second transformer model, a second set of contextual categorical embeddings based, at least in part, on the set of distorted unlabeled categorical embeddings;
compute a self-supervised loss by comparing the first set of contextual categorical embeddings and the second set of contextual categorical embeddings; and
fine-tune the second transformer model based, at least in part, on the self-supervised loss, wherein the fine-tuning comprises adjusting the set of second transformer weights.

16. The server system as claimed in claim 14, wherein the second set of semi-supervised learning operations comprises:
initialize the second transformer model based, at least in part, on a set of second transformer weights;
generate a set of labeled categorical embeddings based, at least in part, on the set of labeled categorical features;
generate a set of distorted labeled categorical embeddings based, at least in part, on the set of labeled categorical embeddings;
generate a set of distorted unlabeled categorical features based, at least in part, on the set of unlabeled categorical features;
generate a set of distorted unlabeled categorical embeddings based, at least in part, on the set of distorted unlabeled categorical features;
generate, via the second transformer model, a third set of contextual categorical embeddings based, at least in part, on the set of labeled categorical embeddings and the set of unlabeled categorical embeddings;
generate, via the second transformer model, a fourth set of contextual categorical embeddings based, at least in part, on the set of distorted labeled categorical embeddings and the set of distorted unlabeled categorical embeddings;
compute a semi-supervised loss by comparing the third set of contextual categorical embeddings and the fourth set of contextual categorical embeddings; and
fine-tune the second transformer model based, at least in part, on the semi-supervised loss, wherein the fine-tuning comprises adjusting the set of second transformer weights.

17. The server system as claimed in claim 10, wherein the server system is further caused, at least in part, to:
receive an input data sample, the input data sample being a data sample for which a prediction has to be performed for a downstream task;
generate, via the third transformer model, an input embedding based, at least in part, on the input data sample; and
generate, via a prediction head, an outcome prediction for the downstream task based, at least in part, on the input embedding.

18. The server system as claimed in claim 17, wherein the prediction head is selected based, at least in part, on the downstream task.

19. A non-transitory computer-readable storage medium comprising computer-executable instructions that, when executed by at least a processor of a server system, cause the server system to perform a method comprising:
accessing a tabular dataset from a database associated with the server system, the tabular dataset comprising tabular data related to a plurality of entities, the tabular data comprising labeled data and unlabeled data;
generating a set of labeled features based, at least in part, on the labeled data, the set of labeled features comprising a set of labeled numerical features and a set of labeled categorical features;
generating a set of unlabeled features based, at least in part, on the unlabeled data, the set of unlabeled features comprising a set of unlabeled numerical features and a set of unlabeled categorical features;
determining, via a first transformer model, a set of contextual numerical embeddings based, at least in part, on the set of labeled numerical features and the set of unlabeled numerical features;
determining, via a second transformer model, a set of contextual categorical embeddings based, at least in part, on the set of labeled categorical features and the set of unlabeled categorical features;
generating a set of concatenated embeddings based, at least in part, on concatenating the set of contextual numerical embeddings and the set of contextual categorical embeddings; and
generating a third transformer model based, at least in part, on the set of concatenated embeddings.

20. The non-transitory computer-readable storage medium as claimed in claim 19, wherein the method further comprises:
receiving an input data sample, the input data sample being a data sample for which a prediction has to be performed for a downstream task;
generating, via the third transformer model, an input embedding based, at least in part, on the input data sample; and
generating, via a prediction head, an outcome prediction for the downstream task based, at least in part, on the input embedding.
